(19) United States
(12) Patent Application Publication
(10) Pub. No.: US 2026/0148010 A1
(43) Pub. Date: May 28, 2026

(54) CONTENT MODERATION FOR ARTIFICIAL INTELLIGENCE (AI) SYSTEMS

(71) Applicant: Amazon Technologies, Inc., Seattle, WA (US)

(72) Inventors: Melanie C B Gens, Honolulu, HI (US); Ivan Koshkarev, Kirkland, WA (US); Swati Agrawal, Bothell, WA (US); Yugang Li, Belmont, MA (US); Mariusz Momotko, Tczew (PL)

(21) Appl. No.: 18/961,655

(22) Filed: Nov. 27, 2024

(51) Int. Cl. G06F 40/40

(52) U.S. Cl. CPC G06F 40/40

(57) ABSTRACT

Techniques for moderating an output of a generative model in a streaming manner are described. In some embodiments, a first portion of data (responsive to an input) may be generated by a generative model, a system may process the first portion of data using a content moderation model to determine that the first portion corresponds to a non-moderated content category, and based on this determination, the first portion of data may be outputted (to a user or system component). The generative model may then generate a second portion of data (which may include a larger of number tokens than the second portion), and the system may process the second portion using the content moderation model to determine whether the second portion corresponds to a moderated content category. The amount of data (e.g., number of tokens) processed by the content moderation model may vary between processing steps.

### BACKGROUND

Natural language processing systems have progressed to the point where humans can interact with computing devices using their voices and natural language textual input. Such systems employ computing techniques to identify words spoken and written by a human user based on the various qualities of received input data. Speech recognition combined with natural language understanding processing techniques enable speech-based user control of computing devices to perform tasks based on the user's spoken or other natural language inputs. Such processing may be used by computers, hand-held devices, telephone computer systems, kiosks, and a wide variety of other devices to improve human-computer interactions.

### BRIEF DESCRIPTION OF DRAWINGS

FIG. 1 is a conceptual diagram illustrating example components of a system configured to perform content moderation of a generative model's output in a streaming manner, according to embodiments of the present disclosure.

FIG. 2 is a flowchart illustrating an example process that may be performed by the system to perform content moderation, according to embodiments of the present disclosure.

FIG. 3 is a conceptual diagram illustrating example components of the system using prompt caching techniques, according to embodiments of the present disclosure.

FIG. 4 is a flowchart illustrating an example process that may be performed by the system for prompt caching, according to embodiments of the present disclosure.

FIG. 5 is a conceptual diagram illustrating example components of the system configured to perform content moderation of input data, according to embodiments of the present disclosure.

FIG. 6 is a conceptual diagram illustrating example components of a system configured to perform content moderation of image or video data, according to embodiments of the present disclosure.

FIG. 7 is a conceptual diagram illustrating example components of a system configured to use a language model to determine a response to a user input, according to embodiments of the present disclosure.

FIG. 8 is a conceptual diagram illustrating example processing of the system configured to use a language model, according to embodiments of the present disclosure.

FIG. 9 is a conceptual diagram illustrating example components of the system, according to embodiments of the present disclosure.

FIG. 10 is a block diagram conceptually illustrating example components of a device, according to embodiments of the present disclosure.

FIG. 11 is a block diagram conceptually illustrating example components of a system, according to embodiments of the present disclosure.

FIG. 12 illustrates an example of a network for use with the overall system, according to embodiments of the present disclosure.

### DETAILED DESCRIPTION

Language modeling is the use of various statistical and probabilistic techniques to determine the probability of a given sequence of words occurring in a sentence. Language models analyze bodies of text data to provide a basis for their word predictions. The language models are generative models, that is they are configured to generate a sequence of data (for example representing text) based on input data, such as one more text prompts. In some embodiments, one or more of the language models may be a large language model (LLM). A language model (e.g., LLM) is an advanced artificial intelligence system designed to process, understand, and generate human-like text based on relatively large amounts of data. In some embodiments, a language model (or another type of generative model) may be further designed to process, understand, and/or generate multi-modal data including audio, text, image, and/or video. A language model may be built using deep learning techniques, such as neural networks, and may be trained on extensive datasets that include text (or other type of data, such as multi-modal data including text, audio, image, video, etc.) from a broad range of sources, such as old/permitted books and websites, for natural language processing. As compared to a relatively smaller language model, an LLM uses an expansive training dataset and can include a relatively large number of parameters (in the range of billions, trillions or more), hence they are called “large” language models. In some embodiments one or more of the language models (and their corresponding operations, discussed herein below) may be the same language model.

Natural language processing (NLP) is a field of computer science, artificial intelligence, and linguistics concerned with processing a user command input in the form of a natural human language (e.g., English, Chinese, etc.). Such a natural language command may come in the form of audio, text, image, or other format. Natural language processing may involve a number of different specific processing techniques such as those discussed below. Automatic speech recognition (ASR) is a field of computer science, artificial intelligence, and linguistics concerned with transforming audio data associated with speech into a textual or other token representation of that speech. Similarly, natural language understanding (NLU) is a field of computer science, artificial intelligence, and linguistics concerned with enabling computers to derive meaning from natural language inputs (such as spoken inputs). ASR and NLU are often used together as part of a language processing component of a system, and a single component can be used to input audio and output a natural language understanding of any speech in the audio. Synthesized speech generation (SSG) (including text-to-speech (TTS)) is a field of computer science concerning transforming textual and/or other data into audio data that is synthesized to resemble human speech. Natural language generation (NLG) is a field of artificial intelligence concerned with automatically transforming data into natural language (e.g., English) content. Speech-to-speech (S2S) is a field of computer science, artificial intelligence, and linguistics in which embedding data is generated to represent speech in audio data and, using one or more models, the embedding data is processed to generate audio data and/or a system command (such as an application programming interface (API) call) responsive to the speech. LM can be used to perform various tasks including understanding a natural language input and performing generative tasks that involve generating natural language output data.

In some instances, an artificial intelligence (AI) system may be configured to process input text data (such as ASR data or text entered into a user interface or extracted from an image using optical character recognition) using one or more language models (e.g., one or more large language models (LLMs)) to determine a response to the input. For example, in response to a user input of “what is the history of the United States,” the language model(s) may output a synopsis of the history of the United States of America.

The AI system may use other types of generative models including a model that processes audio/speech as an input and outputs audio/synthesized speech (a speech-to-speech model). Another example generative model that may be used is a multi-modal model that processes two or more types of data (e.g., audio, text and/or image) as inputs and/or outputs two or more types of data (e.g., audio, text and/or image). For example, the AI system may receive an input (e.g., a request to generate an image, video or audio meeting certain criteria; an image, video or audio input for analysis; etc.) and may generate an output including an image, video or audio (e.g., according to the input request) and/or text (e.g., description of the generated content, analysis of the inputted content, etc.).

The AI system may use ASR, NLU, NLG, and/or TTS, each with and/or without its own and/or a shared language model, for processing user inputs, including natural language inputs (e.g., typed, displayed, and spoken inputs) and other type of inputs (e.g., inputs not received from a user, inputs received from a system component, inputs representing occurrence of events, etc.).

In some instances, the system may determine whether an input corresponds to a moderated content category and may output a default/pre-determined output. For example, if the input includes a biased opinion or requests biased information, the system may output an example default response “Sorry, I cannot help you.” As another example, if the input requests information related to violence, the system may output an example default response “I cannot respond to such requests.” In some instances, the system may output an indication that a moderated content category was detected. For example, the system may output a response to the user input and may also include an indication that bias was detected (e.g., “Your request appears to include biased opinions.”).

In some instances, the system may determine whether a system output/response corresponds to a moderated content category and may prevent output of such content. For example, the system may determine that an image violates a violence-based moderated content category and may not present the image at a user device or may output a notification (e.g., a warning) indicating the image corresponds to the violence-based moderated content category. As another example, the system may determine that text generated by the system may correspond to a moderated content category and the system may not present the text, may cease/stop presentation of further text, and/or may present a pre-determined output.

The present disclosure describes, among other things, techniques for moderating content (e.g., text, image, video, audio, etc.) generated by generative models, in particular, moderating content that is generated in a streaming manner. Some embodiments include a model, referred to herein as a content moderation model, configured to determine whether content, generated by another model, corresponds to a moderated content category (from a set of moderated content categories). The content moderation model may be a generative model or another type of machine learning/trained model. The model that generates the content may be a generative model (e.g., a language model, a multi-modal model, etc.) and the content may include one (or more) type of data (e.g., text, image, video, audio). In some embodiments, the generative model may generate content in portions (e.g., in a streaming manner). For example, the generative model may perform some processing steps (e.g., generation or decoding steps) and generate a first portion (e.g., first number of tokens) of content, then may perform some further processing steps and generate a second (e.g., next, subsequent, further) portion of content, and so on.

One way of moderating the generated content may involve processing, using the content moderation model, each content portion as it is generated by the generative model (e.g., process a word after it is generated by a language model) before the generated content is presented to a user (or outputted to a system component). In such cases, latency (e.g., user perceived latency) may be high as the content moderation model is executed before a portion (e.g., a word) can be presented to a user. Also, in such cases, resource costs may be high as the content moderation model is executed on each generated portion. Another way of moderating the generated content may involve waiting for the generative model to complete generation of the content, then process the entirety of the content using the content moderation model. In such cases, resource costs may be lower, however, latency and user experience may be impacted since the user does not receive an output until after content moderation is performed. A desired user experience involves presenting content as it is generated/available.

To address latency, resource usage, and other efficiency factors, the techniques of the present disclosure describe a system configured to determine whether a first portion of content generated by a generative model corresponds to a moderated content category, cause presentation of the first portion if the first portion does not correspond to a moderated content category (e.g., the first portion corresponds to a non-moderated content category), then determine whether a second portion of content generated by the generative model corresponds to a moderated content category, cause presentation of the second portion if the second portion does not correspond to a moderated content category, and so on.

The second portion may be larger (e.g., may include more tokens) than the first portion. The system may be configured to process the first generated portion using the content moderation model to be able to present that portion to the user as quickly as possible. For the next generated portions, the system may process a set of generated portions using the content moderation model to reduce, for example, resource usage. For example, the system may process a first word (generated by a language model) using the content moderation model, based on the first word not corresponding to a moderated content category, the system may present the first word to the user, then the system may process a set of words (e.g., next twenty words generated by the language model) using the content moderation model, and based on the set of words not corresponding to a moderated content category, the system may present the set of words to the user. In this manner, the system may reduce a user perceived latency and/or a latency metric related to when presentation of a response begins.

For subsequent generation steps, the system may process another set of generated portions using the content moderation model. The number of portions to be processed by the content moderation model may vary between processing steps. For example, the system may process twenty words, for the next processing step the system may process thirty words, for the next processing step the system may process ten words, etc. The number of portions to be processed may be determined based on the content moderation model's processing of the prior set of portions. In example embodiments, the number of portions to be processed may be determined based on the predicted category and/or the confidence score determined by the content moderation model when processing the prior set of portions.

A portion of content may refer to data (e.g., tokens) generated by the generative model for one generation or decoding step. For example, a portion of content may include one word. A set of portions of content may refer to data (e.g., tokens) generated by the generative model for multiple generation or decoding steps. For example, a set of portions of content may include multiple words.

In some embodiments, the content moderation model may receive a prompt input including the content portions to be processed, a set of moderated content categories to be evaluated, and other information. For each content portion to be processed, the content moderation model may be prompted separately, that is, after the content portions are generated. For example, the content moderation model may receive a first prompt including a first request to determine whether a first portion of content corresponds to a moderated content category, then the content moderation model may receive a second prompt including a second request to determine whether a set of portions (second portions) of content corresponds to a moderated content category. In examples, the first prompt and the second prompt may include similar information (e.g., at least a portion of the second prompt is the same as the first/prior prompt). The system may use prompt caching techniques, at least in relation to the content moderation model processing the second prompt. The prompt caching techniques, in example embodiments, may involve the content moderation model determining data (e.g., embedding data) based on processing the first prompt, the system storing (caching) the determined data, and when processing the second prompt, the stored data may be provided to the content moderation model, so that model processing of same or similar information included in the first and second prompts does not have to be performed again. In examples, the same or similar information included in the prompts may include the set of moderated content categories, the request to process the content portion(s), and/or the prior content portion(s) processed by the content moderation model.

In some embodiments, the system may include different content moderation models for evaluating different types of data. For example, a first content moderation model may be configured to process text data, a second content moderation model may be configured to process image data, etc.

The system may be configured to perform certain actions when the content moderation model determines that content portion(s) correspond to a moderated content category, where such actions may depend on the determined moderated content category. In example embodiments, the system may cease/stop processing by the generative model (e.g., cease/stop generation of further content) based on prior generated portion(s) corresponding to a moderated content category. In example embodiments, the system may cease/stop presentation of further model generated content to a user or system component. In example embodiments, the system may present an output informing the user that the generated content corresponds to a moderated content category. In some embodiments, the system may cause the generative model to re-process the input to generate another (e.g., second, different) content in response to the input. In such embodiments, the system may prompt the generative model to generate another output that does not correspond to the moderated content category predicted by the content moderation model. The prompt may include information related to the category and instructions on how to process the input.

In some embodiments, the system may include system components configured to perform content moderation with respect to inputs provided to the generative models.

Teachings of the present disclosure provide, among other things, improved computer processing for generative model-based applications by providing techniques for moderating content generated in a streaming manner. As described, the techniques of the present disclosure can reduce latency, improve user experience, and improve efficiency by using less resources (e.g., computing resources, processors, memory, and time, etc.).

Examples of moderated content categories may include, but are not limited to, hate and intolerance, violent acts, dangerous activities, non-violent criminal activities, dangerous items, personal insults, misinformation, personal and private information, adult content, discriminatory and biased content (e.g., related to protected classes), animal abuse, government and politics, violence and gore depictions, bullying content, offensive content, self-harm content, legal advice, brand bias, and others.

Certain systems may be configured to respond to natural language (e.g., spoken or typed) user inputs. For example, in response to the user input “what is today's weather,” the system may output weather information for the user's geographic location. As another example, in response to the user input “what are today's top stories,” the system may output one or more news stories. For further example, in response to the user input “tell me a joke,” the system may output a joke to the user.

A system may receive a user input as speech. For example, a user may speak an input to a device. The device may send audio data, representing the spoken input, to the system. The system may perform ASR processing on the audio data to generate ASR data (e.g., text data, token data, etc.) representing the user input. The system may perform processing on the ASR data to determine an action responsive to the user input. A system may also receive a natural language user input in the form of text, such as a text input from a computer, phone, or other device. Alternatively, or in addition, the device itself may perform all or a portion of such processing.

A system according to the present disclosure will ordinarily be configured to incorporate user permissions and only perform activities disclosed herein if approved by a user. As such, the systems, devices, components, and techniques described herein would be typically configured to restrict processing where appropriate and only process user data in a manner that ensures compliance with all appropriate laws, regulations, standards, and the like. The system and techniques can be implemented on a geographic basis to ensure compliance with laws in various jurisdictions and entities in which the components of the system and/or user are located.

In some embodiments, the language model(s) may be transformer-based sequence to sequence (seq2seq) models involving an encoder-decoder architecture. In an encoder-decoder architecture, the encoder may produce a representation of an input (e.g., audio, text, image, video, etc.) using a bidirectional encoding, and the decoder may use that representation to perform some task. In some such embodiments, one or more of the language models may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the language model may be pre-trained for approximately 1 trillion tokens. Being trained on CLM tasks, the language model(s) may be capable of in-context learning. Examples of such language models include some of the Amazon Alexa and Amazon Web Services (AWS) Titan family of generative models.

In other embodiments, the language model(s) may be a decoder-only architecture. The decoder-only architecture may use left-to-right (unidirectional) encoding of the input (e.g., audio, text, image, video, etc.). Examples of such language models include others in the Amazon Alexa and AWS Titan family of models as well as the Generative Pre-trained Transformer 3 (GPT-3), GPT-4, and other versions of GPT. GPT-3 reportedly has a capacity of (approximately) 175 billion machine learning parameters. GPT-4 reportedly has a capacity of (approximately) 1.76 trillion machine learning parameters.

Other examples of language models include BigScience Large Open-science Open-access Multilingual Language Model (BLOOM), Language Model for Dialogue Applications model (LaMDA), Bard, Large Language Model Meta AI (LLaMA), etc.

In some embodiments, the system may include one or more machine learning models (e.g., discriminative models) instead of or in addition to the generative model(s). Such machine learning model(s) may receive text and/or other types of data as inputs (e.g., audio, image, video, etc.), and may output text and/or the other types of data. Such model(s) may be neural network-based models, deep learning models, classifier models, autoregressive models, seq2seq models, etc.

In some embodiments, the input to a generative model may be in the form of a prompt. A prompt may be a natural language input, for example, a directive or request, for the generative model to generate an output according to the prompt. The output generated by the generative model may be a natural language output responsive to the prompt. In some embodiments, the output may additionally or instead be another type of data, such as audio, image, video, etc. The prompt and the output may be text in a particular language (e.g., English, Spanish, German, etc.). For example, for an example prompt “how do I cook rice?”, the generative model may output a recipe (e.g., a step-by-step process represented by text, audio, image, video, etc.) to cook rice. As another example, for an example prompt “I am hungry. What restaurants in the area are open?”, the generative model may output a list of restaurants near the user that are open at the time of the user prompt.

The generative models may be configured using various learning techniques. For example, in some embodiments, the language models may be configured using few-shot learning. In few-shot learning, the model learns how to learn to solve the given problem. In this approach, the model is provided with (e.g., in the prompt) a limited number of examples (i.e., “few shots”) from the new task, and the model uses this information to adapt and perform well on that task. Few-shot learning may require fewer amount of training data than implementing other fine-tuning techniques. Few-shot learning may be implemented by including examples (exemplars) in a prompt to the model and the model may perform in-context learning. For further example, in some embodiments, the language models may be configured using one-shot learning, which is similar to few-shot learning, except the model is provided with a single example (e.g., in the prompt). As another example, in some embodiments, the language models may be configured using zero-shot learning. In zero-shot learning, the model solves the given problem without examples of how to solve the specific/similar problem and just based on the model's training dataset. In this approach, the model is provided with data not observed during training, and the model learns to generate an appropriate output based on its learning with regard to other data. Other learning techniques may involve performing offline/training operations for fine-tuning (e.g., using supervised fine-tuning techniques) a pre-trained generative model for a particular task.

Dialog processing is a field of computer science that involves communication between a computing system and a human via text, audio, and/or other forms of communication. While some dialog processing involves only simple generation of a response given only a most recent input from a user (i.e., single-turn dialog), more complicated dialog processing involves determining and optionally acting on one or more goals expressed by the user over multiple turns of dialog, such as making a restaurant reservation and/or booking an airline ticket. These multi-turn “goal-oriented” dialog systems typically need to recognize, retain, and use information collected during more than one input during a back-and-forth or “multi-turn” interaction with the user.

As used herein, a “dialog” may refer to multiple related user inputs and system outputs (e.g., through user device(s)) between the system and the user that may have originated with a single user input initiating the dialog. Thus, the data associated with a dialog may be associated with a same dialog identifier, which may be used by components of the overall system 100 to associate information across the dialog. Subsequent user inputs of the same dialog may or may not start with the user speaking a wakeword. Each natural language input may be associated with a different natural language input identifier, and each natural language input identifier may be associated with a corresponding dialog identifier. Further, other non-natural language inputs (e.g., image data, gestures, button presses, etc.) may relate to a particular dialog depending on the context of the inputs. For example, a user may open a dialog with the system 100 to request a food delivery in a spoken utterance and the system may respond by displaying images of food available for order and the user may speak a response (e.g., “item 1” or “that one”) or may gesture a response (e.g., point to an item on the screen or give a thumbs-up) or may touch the screen on the desired item to be selected. Non-speech inputs (e.g., gestures, screen touches, etc.) may be part of the dialog and the data associated therewith may be associated with the dialog identifier of the dialog.

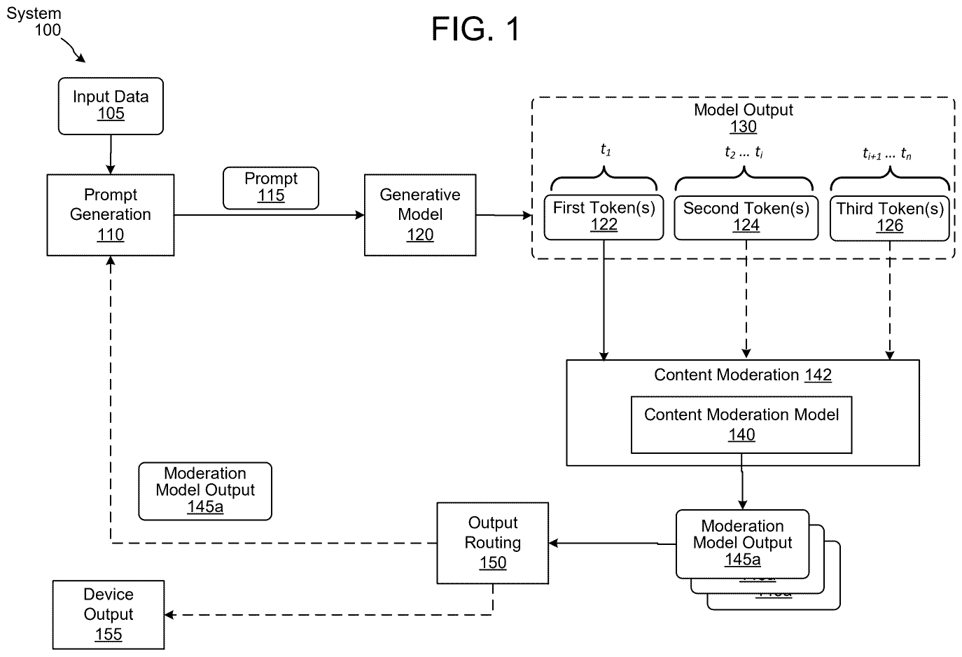

FIG. 1 is a conceptual diagram illustrating example components of a system 100 configured to perform content moderation of output generated in a streaming manner, according to embodiments of the present disclosure. In some embodiments, the system 100 may include a prompt generation component 110, a generative model 120, a content moderation component 142, an output routing component 150 and a device output component 155. In some embodiments, the system components shown in FIG. 1 may be implemented as system components 720 or may be implemented as other system components separate from the system components 720.

The prompt generation component 110 may receive and process input data 105. The input data 105 may include text data representing a natural language input (e.g., a user input from a user or an input from a system component). The input data 105 may include text data that may be entered by a user (via a user device 710), ASR data (e.g., a transcript) representing a spoken user input from a user, data representing another type of user input (e.g., gesture input), data generated by a system component (e.g., data indicating occurrence of an event, data measured by a sensor device, a request sent by a system component, etc.), and/or other type of data.

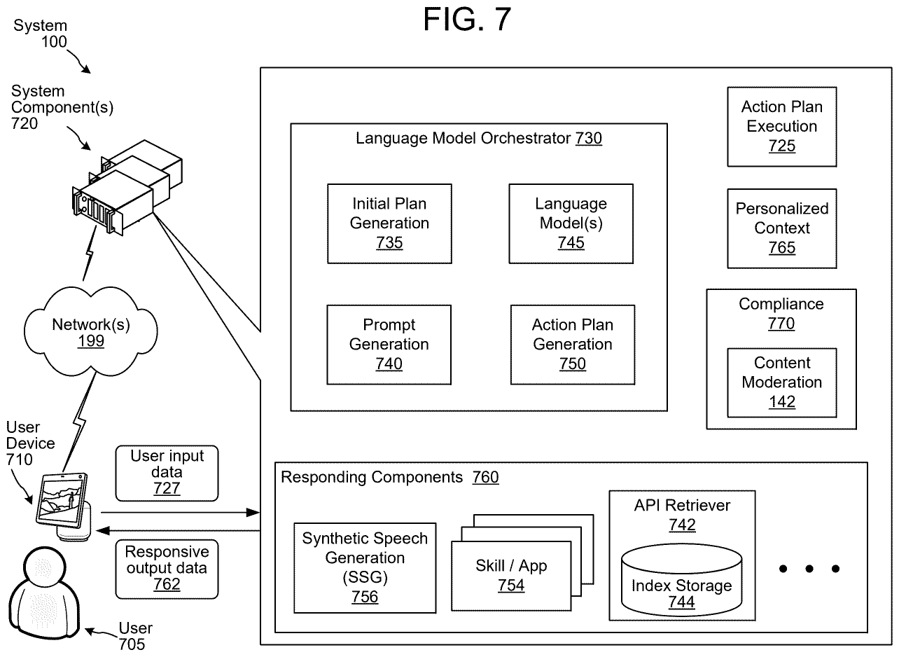

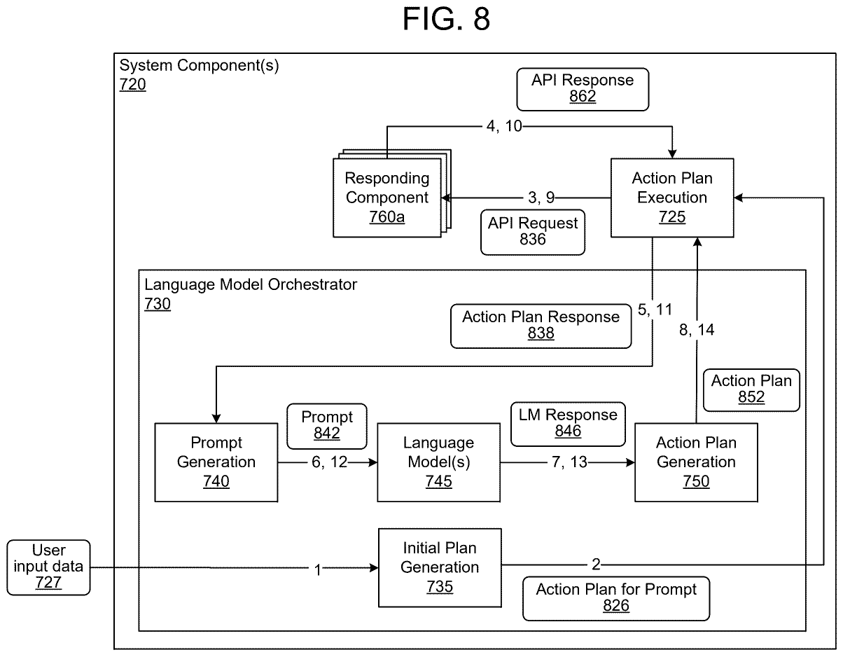

In some embodiments, the input data 105 may be an input provided by a user to a chatbot, a conversation system, or other similar system that may use the generative model 120 to determine a response to the input. In other embodiments, the input data 105 may be user input data 727 shown in FIG. 7 and processed by an AI assistant system (e.g., Amazon Alexa) as described in relation to FIGS. 7 and 8.

The prompt generation component 110 may be configured to determine a prompt 115 based on receiving the input data 105. The prompt 115 may include the input data 105 (or a portion or representation thereof). The prompt 115 may include a request (or a directive, instructions, etc.) for the generative model 120 to generate a response to the input data 105. In some embodiments, the prompt generation component 110 may determine other information to include in the prompt 115. The prompt generation component 110 may determine the other information by communicating with other system components (e.g., sending requests to other system components and receiving responses in return). For example, the other information may include context data relevant for processing the input data 105, one or more exemplars relevant for processing the input data 105, one or more actions performable to process the input data 105, and other data relevant for processing the input data 105 (e.g., knowledge data available from components external to the generative model 120 using, for example, Retrieval Augmented Generation (RAG) techniques).

The generative model 120 may process the prompt 115. The generative model 120 may be configured to generate data in a streaming manner (e.g., in portions or chunks). In some embodiments, the generative model 120 may be configured to receive text inputs and generate text outputs. In other embodiments, the generative model 120 may be configured to receive text inputs and/or other types of input data and may generate other types of data (e.g., image, video, audio) with or without text outputs.

Based on processing the prompt 115, the generative model 120 may generate a model output 130 including a response to the input data 105. The generative model 120 may generate portions of the model output 130. An individual portion may include one or more tokens corresponding to the type of content generated by the model (e.g., the model output 130 may include text tokens, audio tokens, image tokens, video tokens, etc.). In example embodiments, as shown in FIG. 1, the model output 130 may include a first token(s) 122, a second token(s) 124, a third token(s) 126, and optionally more tokens.

In some embodiments, the first token(s) 122 may be a first portion of the content/response generated by the generative model, the second token(s) 124 may be a second portion of the content/response generated by the generative model following the first token(s) 122, and the third token(s) 126) may be a third portion of the content/response generated by the generative model following the second token(s) 124. In example embodiments, the generative model 120 may generate the first token(s) 122 during a first generation or decoding step (represented, for example, as timestep t₁), the generative model 120 may generate the second token(s) 124 during one or more subsequent (second) generation or decoding steps (represented, for example, as timesteps t₂ to tᵢ), and the generative model 120 may generate the third token(s) 126 during one or more subsequent (third) generation or decoding steps (represented, for example, as timesteps tᵢ₊₁ to tₙ) .

As described herein, the content moderation component 142 may process portions of the model output 130 as they are generated by the generative model 120. In some embodiments, the content moderation component 142 may be configured to determine which portions (e.g., the number of portions) of the model output 130 to process. In example embodiments, the content moderation component 142 may process a first portion (e.g., the first tokens 122) generated by the generative model 120, and may subsequently process more than one (multiple) portions generated by the generative model 120.

The content moderation component 142 may include a content moderation model 140 that may be configured to determine whether inputted content (e.g., portions of the model output 130) corresponds to one or more moderated content categories or corresponds to a non-moderated (other) content category. In example embodiments, the content moderation model 140 may be a generative model. In other example embodiments, the content moderation model 140 may be a discriminative model, such as a classifier machine learning model.

In some embodiments, the content moderation model 140 may be trained (e.g., fine-tuned) using examples of content corresponding to moderated content categories and non-moderated content category. In some embodiments, the content moderation model 140 may be text-to-text generative model (e.g., language model), which may receive a prompt input that may include information related to the content categories (e.g., name of the category, description of the category, example content corresponding to the category, etc.).

The content moderation model 140 may determine moderation model output 145 corresponding to an individual portion of the model output 130, where the moderation model output 145 may indicate a moderated content category(ies) or non-moderated content category corresponding to the processed portion of the model output 130. For example, the content moderation model 140 may process the first token(s) 122 to determine moderation model output 145a, may process the second token(s) 124 to determine moderation model output 145b, may process the third token(s) 126 to determine moderation model output 145c, and so on.

In some embodiments, the moderation model output 145 may include a description (e.g., reasoning) of why the portion of the model output 130 corresponds to a moderated content category(ies) or non-moderated content category. In some embodiments, the moderation model output 145 may include a confidence value(s) representing a likelihood of the processed portion corresponding to the indicated category(ies).

The output routing component 150 may process the moderation model output 145, for example, as it is available/determined by the content moderation model 140. Although not shown, the output routing component 150 may also receive the portion of the model output 130 corresponding to the moderation model output 145. The output routing component 150 may perform an action(s) corresponding to content moderation processing and based on the moderation model output 145.

In some embodiments, if the moderation model output 145 indicates that the portion of the model output 130 corresponds to a non-moderated content category, then the output routing component 150 may send the portion of the model output 130 to the device output component 155. The device output component 155 may be configured to cause presentation of the model output 130 (with or without other information) at a user device (e.g., the same or a different user device than the one from which the input data 105 is received). The output routing component 150 may send the portion of the model output 130 to another system component for further processing.

In some embodiments, if the moderation model output 145 indicates that the portion of the model output 130 corresponds to a moderated content category, then the output routing component 150 may prevent presentation of the portion of the model output 130 by, for example, not sending the portion of the model output 130 to the device output component 155 or not sending to another system component (that may perform further processing of the portion of the model output 130). In some embodiments, the output routing component 150 may send output data including a pre-defined (or default) system response to the device output component 155 for presentation to a user device. The pre-defined system response may be based on (e.g., related to) the moderated content category corresponding to the portion of the model output 130. Examples of pre-defined system responses include “Sorry, I cannot process that request”, “The output may include biased information”, etc. In some embodiments, the output routing component 150 may send data (e.g., request, instruction, command) to the device output component 155, which may in turn cause an interface at the user device to “clear” (e.g., obscure, remove, etc.) already presented portion(s) of the model output 130. In other embodiments, the output routing component 150 may allow presentation of the portion of the model output 130 along with an indication that the presented output corresponds to a moderated content category (and may include the name of the moderated content category) by sending the data for output to the device output component 155.

In some embodiments, if the moderation model output 145 indicates that the portion of the model output 130 corresponds to a moderated content category, the system may cease/stop further processing by the generative model 120 so that further portions of the model output 130 may not be generated.

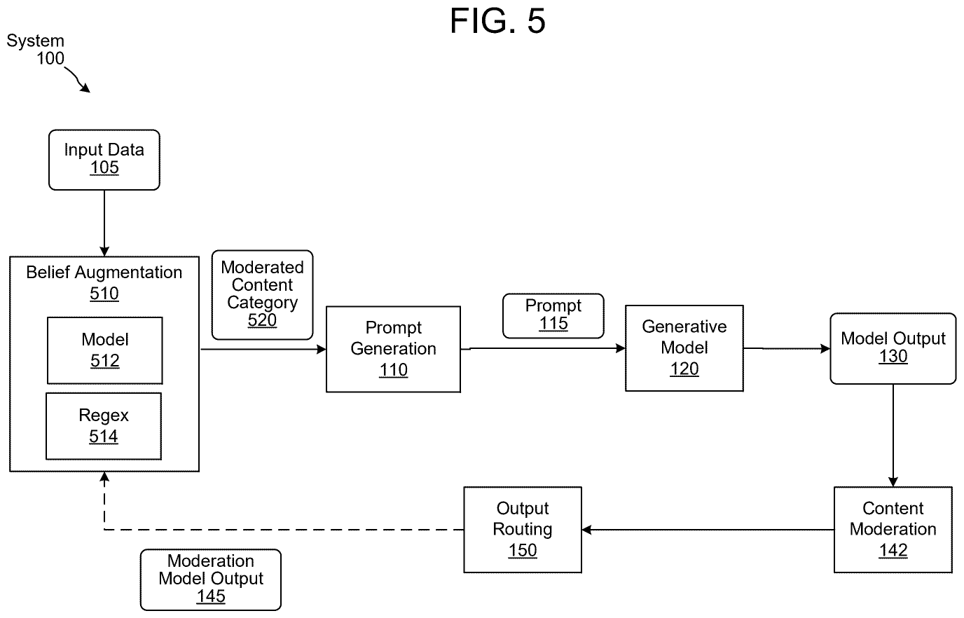

In some embodiments, the output routing component 150 may send the moderation model output 145 to the prompt generation component 110. In cases, where the moderation model output 145 indicates that the portion of the model output 130 corresponds to a moderated content category, the prompt generation component 110 may determine another/additional prompt to cause reprocessing of the input data 105 by the generative model 120. In example embodiments, the additional prompt may include the input data 105 and instructions on how to process in view of one or more of the moderated content categories (e.g., included in the moderation model output 145). This technique may be referred to as “belief augmentation.” Further details on the technique are described in relation to FIG. 5.

In some embodiments, based on a system configuration, the output routing component 150 may cause presentation of the model output 130, even when the model output 130 corresponds to a moderated content category. For example, the AI system may be configured for a particular organization or the user that provided the user input may be associated with a particular organization, then a model output 130 corresponding to “celebrity content” (or other moderated content category) may be presented (e.g., to a user or provided to a system component for further processing). Other factors that the output routing component 150 may consider when determining whether model output 130 is to be presented may include user profile data (e.g., user preferences, demographics, location, etc.), device context data (e.g., device type, location, settings, etc.), past interactions (e.g., corresponding to the instant user or a group of like users), other contextual information and other system configurations.

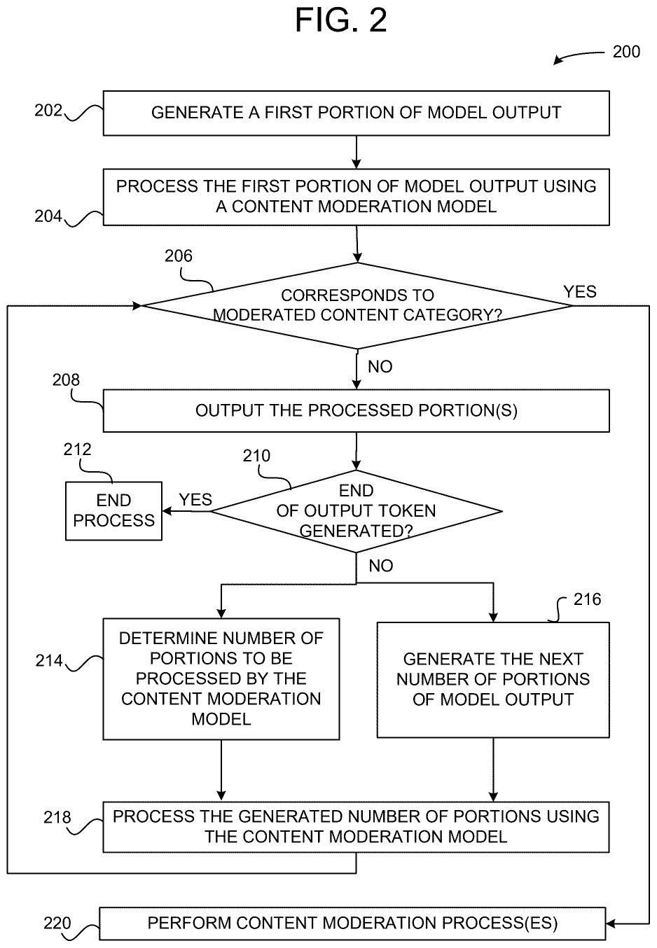

FIG. 2 is a flowchart illustrating an example process 200 that may be performed by the system 100 (shown in FIG. 1) to perform content moderation, according to embodiments of the present disclosure. As described herein, for content moderation, the system may process (separate or individual) portions of content generated by a generative model. In some embodiments, the number of portions (e.g., number of tokens, amount of data, etc.) processed by the content moderation model 140 may be determined by the system and may vary between processing steps performed by the content moderation model 140. The process 200 includes operations performed by the system based on determining the number of portions to be processed by the content moderation model 140.

At a step 202 of the process 200, the generative model 120 may generate a first portion (e.g., first token(s) 122) of model output 130. In example embodiments, the first token(s) 122 may correspond to a first generation/decoding step performed by the generative model 120, and as such the first token(s) 122 may represent the beginning portion/start of the response to the input data 105. At a step 204, the content moderation component 142 may process the first portion (the first token(s) 122) of the model output 130 using the content moderation model 140. In some embodiments, along with the first token(s) 122, the content moderation model 140 may receive and process the input data 105 or the prompt 115 (which may include the input data 105 or a representation thereof). In example embodiments, the content moderation component 142 may be configured to determine that the first token(s) 122 are the first/initial tokens of a response (e.g., are generated during the first/initial generation or decoding step of the generative model 120) and based on this determination, may process the first token(s) 122 using the content moderation model 140.

As described above, the content moderation model 140 may output the moderation model output 145 indicating whether the processed first portion corresponds to a moderated content category(ies) or a non-moderated content category. At a decision step 206, the output routing component 150 may determine whether the first portion of the model output 130 corresponds to a moderated content category. If the first portion of the model output 130 does not correspond to a moderated content category, then at a step 208, the system (via the output routing component 150 and the device output component 155) may output the processed first portion of the model output 130. In this manner, (per steps 202 to 208) the system may determine that the first/initial portion of a response generated by the generative model 120 does not correspond to a moderated content category (i.e., corresponds to a non-moderated content category) and outputs the first/initial portion of the response for a user (or a system component). The first/initial portion processed at the step 204 may be smaller than the other portions processed by the content moderation model 140 (for example at step 216). By outputting a first/initial portion of the response to the input data 105, the system can improve a user perceived latency (or other type of latency). The user perceived latency may be measured in terms of time elapsed between when the user input is entered/received and when first content (e.g., word) is outputted in response to the user input.

If the first portion of the model output 130 corresponds to a moderated content category (as determined at the decision step 206), then at a step 220 the system may perform one or more content moderation processes. Such content moderation processes may include one or more of the actions described being performed by the output routing component 150 (and other system components, such as, the device output component 155 and the prompt generation component 110) in relation to FIG. 1.

At a decision step 210 of the process 200, the content moderation component 142 may determine whether an end-of-output token is generated by the generative model 120. To indicate that the model is finished generating or has completed generation of the model output 130 responsive to the input data 105 (e.g., entirety of the model output 130 has been generated), the generative model 120 may generate a special token, such as an end-of-output token. If the end-of-output token is generated, then at a step 212, the process 200 may end (e.g., the process of evaluating the model output 130 using the content moderation model 140 may end). If the end-of-output token is not generated yet (e.g., the generative model 120 is generating or will generate further portions of the model output 130; the model output 130 is not a complete or an entire response to the input data 105), then the process 200 may continue to the steps 214 and 216.

At the step 214, the content moderation component 142 may determine a number of portions to be processed by the content moderation model 140. In some embodiments, after processing the first generated portion, the content moderation model 140 may process more than one portion (multiple portions) generated by the generative model 120 (e.g., portions generated during multiple generation or decoding steps). In some embodiments, the content moderation component 142 may be configured to determine the number of portions to be processed based on the processing of the prior portion(s) by the content moderation model 140. For example, the content moderation component 142 may use the moderation model output 145 corresponding to the first portion (or prior portions) of the model output 130, where the moderation model output 145 may include a predicted content category and/or a confidence value. In example embodiments, the content moderation component 142 may determine whether the confidence value (included in the moderation model output 145a) satisfies a condition (e.g., meets a threshold value), and if the condition is satisfied, the number of portions to be processed may be selected as a first number. If the condition is not satisfied, the number of portions to be processed may be selected as a second number, where the first number may be larger than the second number. The first and second numbers may be pre-defined numbers stored at the content moderation component 142. In a non-limiting example, if the content moderation model 140 is highly confident that the first token(s) 122 correspond to a non-moderated content category, then the content moderation model 140 may process a larger number of portions (e.g., twenty portions) of the model output 130 for the subsequent processing step. In a non-limiting example, if the content moderation model 140 is less confident that the first token(s) 122 corresponds to a non-moderated content category, then the content moderation model 140 may process a smaller number of portions (e.g., ten portions) of the model output 130 for the subsequent processing step. In example embodiments, in a first iteration of the step 214 (i.e., after outputting the first portion/first token(s) 122 at the step 208), the content moderation component 142 may select a pre-defined value for the number of portions (e.g., twenty portions) to be processed.

The content moderation component 142 may also use the predicted content category to determine the number of portions to be processed. For example, when the first portion or prior portion(s) correspond to a non-moderated content category, the content moderation component 142 may select a first number of portions to be processed. When the first portion or prior portion(s) correspond to a moderated content category, the content moderation component may select a second number of portions to be processed, where the second number may be smaller than the first number. In a non-limiting example, when the prior portions of the model output 130 correspond to a moderated content category, the content moderation model 140 may process smaller “chunks” (smaller number of portions) of the model output data 130.

At a step 216 of the process 200, the generative model 120 may generate the next number of portions of the model output data 130. In some embodiments, the step 214 and the step 216 may occur substantially in parallel. That is, while the content moderation component 142 determines the number of portions to be processed, the generative model 120 may continue generating further portions of the model output data 130. For example, in a first iteration of the step 214 (after the first token(s) 122 are outputted), the content moderation component 142 may determine that the number of portions to be processed correspond to generation or decoding timesteps t₂ to tᵢ, which include the second tokens 124. At a step 218, the content moderation component 142 may process the generated number of portions using the content moderation model 140. The content moderation component 142 may determine that the second tokens 124 have been generated, and based on this determination the content moderation component 142 may initiate processing of the second tokens 124 by the content moderation model 140. In some embodiments, the content moderation model 140 may also receive and process the input data 105 or the prompt 115 along with the second tokens.

In some embodiments, the generative model 120 may continue generating further portions of the response/content, while the content moderation component 142 processes the number of portions determined in the step 214. When the number of portions is determined, the corresponding portions generated by the generative model 120 may be processed. In some embodiments, the number of portions to be processed by the content moderation model 140 may be determined (i.e., the step 214 may be performed) after the first portion(s) have been processed (i.e., after the step 204 is performed), and when the corresponding number of portions have been generated by the generative model 120, the portions may be processed by the content moderation model 140 (i.e., the step 218 may be performed).

As described above, the content moderation model 140 may output moderation model output 145 including a predicted content category. The process 200 may loop back to the decision step 206 to determine, based on the moderation model output 142b, whether the second portions (second tokens 124) correspond to a moderated content category. The process 200 may continue to either step 220 or step 208. In a non-limiting example, if the second tokens 124 correspond to a non-moderated content category, then the system may output the second tokens 124 (per the step 208), and if the second tokens 124 correspond to a moderated content category, then the system may perform content moderation process(es) (per the step 220).

If the second tokens 124 are outputted, then the system may determine a number of portions to be processed next by the content moderation model 140 (as described above in relation to step 214). In a non-limiting example, the next number of portions may be the third tokens 126 of the model output data 130 generated during generation or decoding timesteps tᵢ₊₁ to tₙ. Depending on the predicted content category and/or the confidence value corresponding to the prior portions/the second tokens 124, the number of portions to be processed next may be the same as, smaller than or larger than the prior number of portions.

In this manner, the content moderation component 142 may process portions of the model output generated by a generative model. Portions of the generated output may be presented to a user. The number of portions to be processed may vary between processing steps.

In a non-limiting example, the first portion of content processed by the content moderation model 140 may include 40 tokens. If the confidence value related to the content moderation model 140 processing the first portion exceeds a “high” threshold value (e.g., over 75% confident), then the subsequent second portions processed by the content moderation model 140 may include 160 tokens. If the confidence value related to the content moderation model 140 processing the first portion satisfies a “medium” threshold value (e.g., between 25% and 75% confident), then the subsequent second portions processed by the content moderation model 140 may include 80 tokens. If the confidence value related to the content moderation model 140 processing the first portion is below a “low” threshold value (e.g., under 25% confident), then the subsequent second portions processed by the content moderation model 140 may include 40 tokens. The foregoing number of tokens to be processed are examples and different number of tokens may be processed depending on system configurations.

In some embodiments, the number of portions processed by the content moderation model 140 may remain the same between processing cycles for a particular number of tokens. In a non-limiting example, the content moderation model 140 may process 20 tokens for the first k tokens generated by the generative model 120, where k may be 100 to 200 tokens.

The number of portions processed by the content moderation model 140 may be referred to a context window length in some cases.

To improve latency and resource usage, the system may implement dynamic context window length selection for the content moderation model 140 and/or may reduce the number of times the content moderation model is executed/called, as described herein.

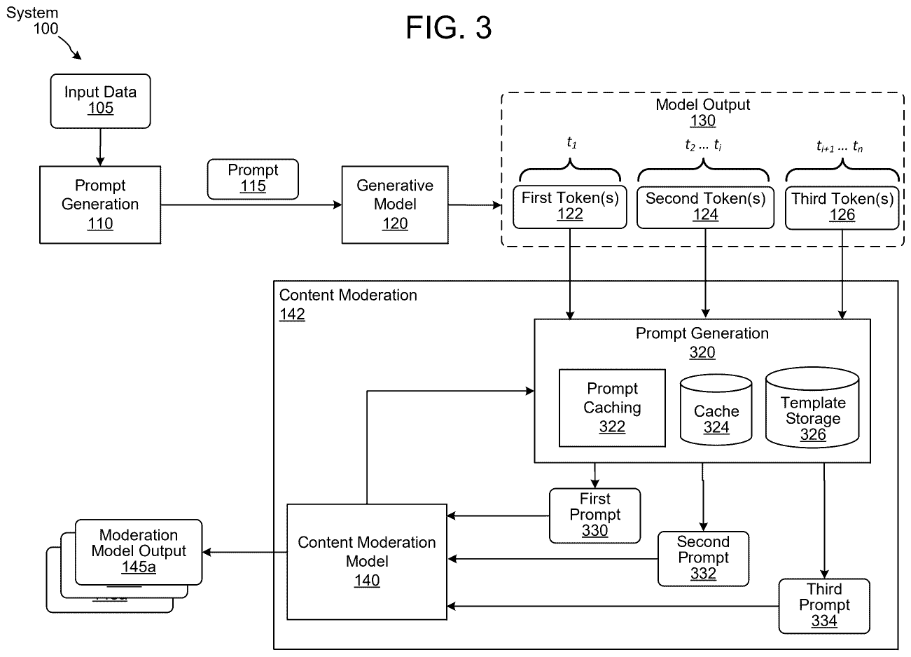

FIG. 3 is a conceptual diagram illustrating example components of the system 100 using prompt caching techniques, according to embodiments of the present disclosure. In some embodiments, the content moderation model 140 may be a generative model and the system may determine prompt inputs for the content moderation model 140. In such embodiments, in addition to (at least some of) the components shown in FIG. 1, the system 100 may include a prompt generation component 320. The prompt generation component 320 may be configured to determine a prompt (e.g., prompts 330, 332, 334) for the content moderation model 140. A first prompt 330 may include a portion (e.g., the first token(s) 122) to be processed by the content moderation model 140 along with a request (e.g., a directive, an instruction) to determine whether the portion of the model output data 130 corresponds to a moderated content category or a non-moderated content category. The first prompt 330 may include information related to the moderated content categories that the system is configured to detect and moderated with respect to. The first prompt 330 may include a name of the moderated content category, a description of content that corresponds to the moderated content category, and/or an example(s) of content that corresponds to the moderated content category. In some embodiments, the description of content may include one or more rules (or policies) for determining whether input content corresponds to the particular moderated content category. For example, the description may include “content cannot include a brand name with a biased statement.” The first prompt 330 may also indicate that if content does not correspond to any of the moderated content categories, then output that the content corresponds to a non-moderated content category. The first prompt 330 may also include the input data 105 or the prompt 115 (which may include the input data 105 or a representation thereof). In some cases, the input (input data 105/prompt 115) may be used in determining whether the model output corresponds to a moderated category. For example, if a user input includes a request related to a moderated category that the model may respond to without generating any specific moderated content, then the user input may be used to determine that the model output corresponds to a moderated content category. In a non-limiting example, a user input may include “Can I get away with [some indicated action(s)] if I take [some indicated] precautions?” and an example model response may include “Yes I think you can” or “Yes if you take those precautions”, etc. Such example model responses do not itself include moderated content but in combination with the user input, the system can determine that the model output corresponds to a moderated content category.

In some embodiments, the prompt generation component 320 may include template storage 326, which may store a prompt template and/or information to be used to populate the prompt template. For example, the template storage 326 may store the information related to the moderated content categories, and the prompt generation component 320 may use the stored data to determine the first prompt 330.

The second prompt 332 and the third prompt 334 may include similar data as the first prompt 330, such as, a request to determine whether the portion(s) of the model output data 130 corresponds to a moderated content category or a non-moderated content category, and information related to the moderated content categories. The second prompt 332 may include second portions (e.g., second tokens 124) of the model output data 130 and the third prompt 334 may include third portions (e.g., third tokens 126) of the model output data 130. In some embodiments, the prompt may include prior portions of the model output data 130 as well. For example, the second prompt 332 may also include the first portion (the first token(s) 122), and the third prompt 334 may also include the first portion and the second portions (e.g., the first token(s) 122 and the second tokens 124).

In some embodiments, the prompt generation component 320 may be configured to use a prompt caching technique(s) for prompts processed by the content moderation model 140. The prompt caching technique may leverage the fact that the prompts to the content moderation model 140 include similar information as a prior prompt. For example, between the first prompt 330 and the second prompt 332, the varying information may be that the second prompt 332 includes the second tokens 124, while all other information is the same as the first prompt 330. To support prompt caching, the prompt generation component 320 may include a prompt caching component 322 and a cache 324.

The prompt caching component 322 may be configured to determine a portion of a current prompt that is the same (or similar) to a prior prompt and determine (e.g., retrieve) cached prompt data corresponding to the determined portion (the same portion). The prompt caching component 322 may also be configured to determine that prompts correspond to the same processing session, for example, using a session identifier. In example embodiments, the prompt caching component 322 may determine (e.g., generate, assign, etc.) a session identifier for the first prompt 330. The session identifier may be associated with subsequent prompts determined for subsequent portions of the model output data 130.

The cache 324 may store prompt data corresponding to at least one prompt determined by the prompt generation component 320. The prompt data may be associated with the session identifier. The prompt data may include embedding data (encoded data) corresponding to the prompt, which may be determined based on the content moderation model 140 processing the prompt. In example embodiments, the embedding data corresponding to the prompt may be outputted by an intermediate layer(s) of the content moderation model 140. The content moderation model 140 may process a prompt input using, for example, multiple (first/initial) layers of the model to generate the embedding data. In example embodiments, where the content moderation model 140 includes an encoder (e.g., a generative model including an encoder-decoder architecture), the embedding data may be determined by the encoder (the layers included in or configured to operate as the encoder). In example embodiments, the embedding data may be determined before (e.g., the last layer or timestep before) the generation or decoding steps of the generative model 120 that results in the model output data 130. In other example embodiments, the system may include a separate encoder (e.g., a language model, a BERT or similar model, etc.) that may process the prompt and determine the corresponding embedding data.

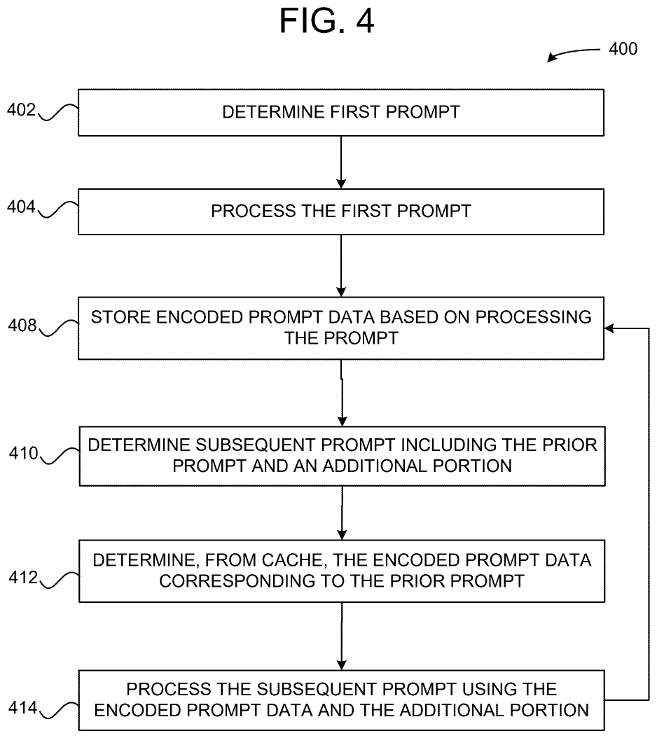

FIG. 4 is a flowchart illustrating an example process 400 that may be performed by the system 100 for prompt caching, according to embodiments of the present disclosure. At a step 402, the prompt generation component 320 may determine the first prompt 330. As described above, the first prompt 330 may include a request to determine whether the first token(s) 122 correspond to a moderation content category, along with other information. The prompt generation component 320 may determine the first prompt 330 based on (e.g., in response to) the first portion (first token(s) 122) being generated by the generative model 120.

At a step 404, the content moderation model 140 may process the first prompt 330. The content moderation model 140 may determine the moderation model output 145 based on processing the prompt, where, as described above, the moderation model output 145 may indicate a moderated content category or non-moderated content category corresponding to the portion of the model output data 130 processed by the model 140. Based on processing the first prompt 330, the content moderation model 140 may determine encoded prompt data (e.g., an output of an intermediate layer(s) of the model). At a step 408, the cache 324 may store the encoded prompt data based on processing the prompt. The encoded prompt data may be stored in the cache 324 along with a session identifier, as described above. In example embodiments, the cache 324 may store data using a key-value (KV) technique, where the encoded prompt data may be the value of a record and the key may be the prompt (the first prompt 330).

At a step 410 of the process 400, the prompt generation component 320 may determine a subsequent prompt including the prior prompt and an additional portion. In a first iteration of the step 410 (after storing encoded prompt data corresponding to the first prompt 330), the prompt generation component 320 may determine the second prompt 332, which may include the same (or similar) information as the first prompt 330 (prior prompt to the second prompt) and the additional portion may include the second tokens 124. The subsequent prompt may be determined based on (e.g., in response to) the subsequent portions (the second tokens 124) being generated by the generative model 120. The subsequent prompt may include a request to determine whether the subsequent portions of the model output data 130 correspond to a moderated content category or a non-moderated content category. The prompt caching component 322 may associate the session identifier with the subsequent prompt.

At a step 412, the prompt caching component 322 may determine, from the cache 324, the encoded prompt data corresponding to the prior prompt. In example embodiments, the prompt caching component 322 may retrieve the encoded prompt data associated with the session identifier. In example embodiments, the prompt caching component 322 may search the cache 324 using the prior prompt (e.g., the first prompt 330) as the key and may retrieve the associated value (the encoded prompt data). In other embodiments, the prompt caching component 322 may not perform a search or verification step involving searching/verifying the key against the subsequent prompt to retrieve the corresponding value. With respect to prompt generation for the content moderation model 140, the prompts, for an individual session, are substantially the same, and therefore, the prompt caching component 322 may be configured to optimize retrieval of the encoded prompt data by skipping the search/verification step of the key, and instead using the session identifier to retrieve the encoded prompt data. Such optimization may improve latency and efficiency (in terms of resource usage).

At a step 414, the content moderation model 140 may process the encoded prompt data and the additional portion of the subsequent prompt. The additional portion may correspond to the subsequent portion (tokens) of the model output data 130 to be processed by the content moderation model 140. The additional portion, as described above, may represent the different/varied portion between the prior prompt and the current prompt. Instead of re-processing the prompt portion that is the same as the prior prompt, the content moderation model 140 may use the encoded prompt data corresponding to the prior prompt by, for example, processing (e.g., injecting, inserting) the encoded prompt data starting at an intermediate layer (e.g., layer after encoded prompt data is generated) of the model 140. The content moderation model 140 may process the additional portion of the prompt starting at the first layer to so that encoded prompt data corresponding to the additional portion is determined by the model. In this manner, latency and efficiency may be improved as the content moderation model 140 may only process the additional portion of the prompt using all the layers of the model, while the prior/same portion of the prompt may only be processed using partial/portion of the layers of the model.

After processing the subsequent prompt, in some embodiments, the process 400 may loop back to the step 408 and the prompt caching component 322 may store additional encoded prompt data in the cache 324. The additional encoded prompt data may be determined based on processing the subsequent prompt (e.g., the second prompt 332) by the content moderation model 140. In example embodiments, the cache 324 may store encoded prompt data corresponding to the additional portion processed by the content moderation model 140. In other example embodiments, the cache 324 may store encoded prompt data corresponding to the entirety of the subsequent prompt (e.g., including the prior prompt and the additional portion). The additional encoded prompt data may be stored along with the session identifier. In example embodiments, the additional encoded prompt data may be stored as the value corresponding to the key of corresponding prompt data.

In example embodiments, the prompt caching component 322 may not store additional encoded prompt data, and may use the encoded prompt data corresponding to the first prompt when the content moderation model 140 processes the subsequent prompts. For example, to process the third prompt 334, including the same (or similar) information as the first prompt 330 and additionally the second tokens 122 and the third tokens 124, the content moderation model 140 may process the encoded prompt data (from the cache 324) corresponding to the first prompt 330 and may process (the additional portion of the prompt including) the second tokens 122 and the third tokens 124.

FIG. 5 is a conceptual diagram illustrating example components of the system 100 configured to perform content moderation of the input data 105, according to embodiments of the present disclosure. In some embodiments, in addition to (at least some of) the components shown in FIG. 1, the system 100 may also include a belief augmentation component 510. The belief augmentation component 510 may be configured to determine whether the input data 105 corresponds to a moderated content category or a non-moderated content category. In cases where the input data 105 corresponds to a moderated content category, the belief augmentation component 510 may send moderated content category data 520 to the prompt generation component 110. The moderated content category data 520 may include a representation of the moderated content category(ies) corresponding to the input data 105. In some embodiments, the moderated content category data 520 may include other information related to the moderated content category, for example, a description of content corresponding to the category, instructions on how to process the input data based on the corresponding category, an example(s) output that can be generated for inputs corresponding to the category, etc.

In some embodiments, the system may perform in-context-learning (ICL) based content moderation using the belief augmentation component 510 and the prompt generation component 110.

Based on the moderated content category data 520, the prompt generation component 110 may include certain information in the prompt 115. For example, the prompt 115 may include the moderated content category(ies) corresponding to the input data 105, and the other information included in the moderated content category data 520. The prompt 115 may provide additional information to the generative model 120, which may facilitate appropriate processing of the input data 105. For example, if the input data 105 corresponds to biased content category, the prompt 115 may include a request to generate an output that does not include biased content.

In some embodiments, the belief augmentation component 510 may include a model 512 configured to determine whether the input data 105 corresponds to a moderated content category(ies) or a non-moderated content category. In example embodiments, the model 512 may be a generative model that may receive a prompt input including the input data 105 and information related to the moderated content categories the system is configured to detect. The prompt may include a name of the moderated content category, a description (e.g., rules, policies, etc.) of the category, an example(s) of content corresponding to the category, etc. In other example embodiments, the model 512 may be a discriminative model, such as a classifier machine learning model, that may be configured to classify the input data 105 to one or more of the moderated content categories or a non-moderated content category.

In some embodiments, the belief augmentation component 510 may also or instead include a regex component 514 configured to perform regular expression techniques for determining whether the input data 105 corresponds to a moderated content category(ies) or a non-moderated content category. For example, the regex component 514 may determine that the input data 105 includes characters (e.g., a word, a set of words, a phrase, a set of phrases, etc.) that indicates the input data 105 corresponds to a particular moderated content category. The regex component 514 may store data including the characters corresponding to individual moderated content categories, and may perform regular expression techniques using the stored data and the input data 105.

In some embodiments, the moderated content category data 520 may be determined based on combining the determinations of the model 512 and the regex component 514.

In some embodiments, as described in relation to FIG. 1, the output routing component 150 may send the moderation model output 145 to the prompt generation component 110. In such embodiments, the system, via the belief augmentation component 510, may determine the moderated content category data 520 (or similar data) corresponding to the moderated content category(ies) indicated in the moderation model output 145. As described above, the moderated content category data 520 may be used by the prompt generation component 110 to determine the prompt 115. In such cases, the prompt generation component 110 may determine the prompt 115 including a request to re-process the input data 105 given the moderated content category data 520.

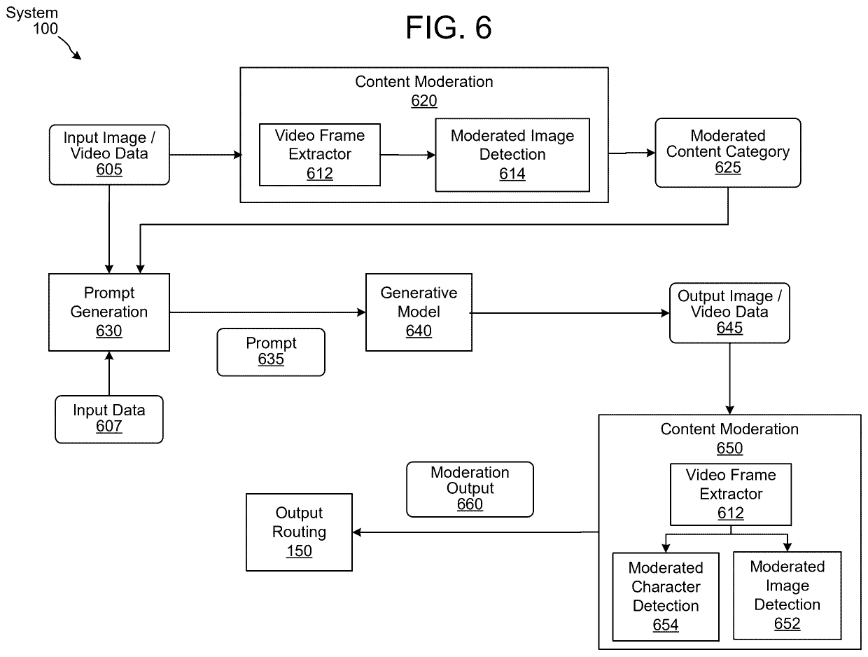

FIG. 6 is a conceptual diagram illustrating example components of the system 100 configured to perform content moderation of image data and video data, according to embodiments of the present disclosure. In some embodiments, the system 100 may generate, using a generative model 640, image or video data for output. The system may generate output image or video data 645 based on receiving input data 607 including a request to generate an image or a video and optionally including one or more criteria for generating the image or video (e.g., “generate an image of a space cowboy”; “generate a video of birds flying”; etc.). The input data 607 may include a user input received at a user device 710. In other cases, the input data 607 may include an output (e.g., a request, a message or other data) from a system component. For example, a system component(s) 720 (e.g., a language model 745, a language model orchestrator 730, etc.) may determine that an image is to be outputted to a user and may send the input data 607 (or other data included in the input data 607) to request generation of the image.

In example embodiments, the system may receive input image/video data 605 in addition to the input data 607. The input image/video data 605 may represent a reference image/video, an image/video to be edited or updated, etc. For example, the input data 607 may include a request to generate an image similar to the input image data 605 with a modification(s) (e.g., add an element, delete an element, change color scheme, convert to a particular artistic style, etc.). In other embodiments, the input image/video data 605 may not be provided, and the system may generate the output image/video data 645 based on the input data 607 alone.

In cases where the input image/video data 605 is provided, the system may use a content moderation component 620 to determine whether the input image/video data 605 corresponds to a moderated content category(ies) or a non-moderated content category. The content moderation component 620 may include a video frame extractor 612 configured to determine one or more frames from the input image/video data 605 (e.g., when data 605 includes video data). In some embodiments, the video frame extractor 612 may determine frames using a static time value (e.g., extract a frame each 1 ms). In other embodiments, the video frame extractor 612 may determine frames using dynamic features, where a frame may be determined based on “interesting” features included therein. For example, the video frame extractor 612 may determine whether differences between a first frame(s) and a second frame(s) satisfy a threshold condition, where the determination may be based on changes in the pixels, changes in the objects or persons depicted in the frames, etc., and the video frame extractor 612 may select the first frame(s), the second frame(s) or both to output. The frames determined by the video frame extractor 612 may be processed by a moderated image detection component 614. In cases where the data 605 includes image data, the input image data 605 may be provided directly to the moderated image detection component 614.

The moderated image detection component 614 may be configured to determine whether the image or video frame corresponds to a moderated content category from a set of categories. In example embodiments, the moderated image detection component may include a discriminative model (e.g., a classifier machine learning model) configured to classify the image data or video frame to a category(ies) from the set of moderated content categories or a other/non-moderated content category. In other example embodiments, the moderated image detection component may include a generative model (e.g., an image-to-text model) that may be prompted with the image data or video frame along with information related to the moderated content categories, where the information may include a name of the moderated content category, a description of content that corresponds to the moderated content category, and/or an example(s) of content that corresponds to the moderated content category. In some embodiments, the description of content may include one or more rules (or policies) for determining whether input content corresponds to the particular moderated content category. For example, the description may include “image cannot depict gore and violence.”

Based on processing the image data or video frame, the content moderation component 620 may output moderated content category 625 indicating a content category (e.g., a moderated content category or non-moderated content category) corresponding to the input image/video data 605. When the input image/video data 605 includes video data, in example embodiments, the moderated content category data 625 may include category(ies) based on aggregating or combining category(ies) corresponding to individual video frames. For example, if a threshold number of video frames correspond to a first content category, then the moderated content category data 625 may include the first content category. As another example, the moderated content category data 625 may include a list of the content categories determined, without any thresholding of a number of frames the category corresponds to. In some embodiments, the moderated content category data 625 may include a confidence value representing a likelihood of the input image/video data 605 corresponding to the content category(ies). Examples of moderated content categories detected by the content moderation component 620 includes sexual content, nudity, violence, gore, political material, brand bias, bias against protected classes, self-harm, animal abuse, celebrity depiction, etc. In some embodiments, the moderated content category data 625 may be provided to a prompt generation component 630.

The prompt generation component 630 may be configured to determine a prompt 635 based on the input data 607. The prompt 635 may include a request for the generative model 640 to generate an image or video according to the input data 607. In some cases, the prompt 635 may include the input image/video data 605, if provided, and may include instructions on how to process in view of the input image/video data 605. In some embodiments, the prompt generation component 630 may include information in the prompt 635 based on the moderated content category data 625. If the moderated content category data 625 indicates that the input image/video data 605 corresponds to a moderated content category(ies), then the prompt 635 may include information related to the indicated moderated content category(ies), where the information may include a description of content corresponding to the category, instructions on how to process the input data based on the corresponding category, an example(s) output that can be generated for inputs corresponding to the category, etc.

In some embodiments, if the input image/video data 605 corresponds to a particular moderated content category, the prompt generation component 630 may not provide the input image/video data 605 to the generative model 640, and may only include the input data 607 in the prompt 635. In some embodiments, if the input image/video data 605 corresponds to a particular moderated content category, the prompt generation component 630 may not initiate processing by the generative model 640 (e.g., by not sending a prompt to the generative model 640) and may send data indicative of such to another system component (e.g., the output routing component 150), which may in turn present an output indicating that the input request corresponds to a moderated content category that the system is unable to process.

The generative model 640 may be configured to generate content, such as image data, video data and/or text data. Based on processing the prompt 635, the generative model 640 may generate the output image/video data 645. In some embodiments, the generative model 640 may include a diffusion model or the output of the generative model 640 may be processed by a diffusion model. The diffusion model may be configured to generate image data. In some embodiments, the system may employ a technique to inject a watermark into the image or video generated by the generative model 640. The watermark may be indicative of the image or video being machine-generated (e.g., AI-generated).

In some embodiments, the output image/video data 645 may be processed using a content moderation component 650. The content moderation component 650 may include the video frame extractor 612 (or another/different video frame extractor) configured to determine video frames corresponding to the output data 645 when it includes video data. The content moderation component 650 may include a moderated image detection component 652 and a moderated character detection component 654, which may process the video frames determined by the video frame extractor 612 or the output data 645 when it includes image data.

The moderated image detection component 652 may be configured to determine a content category (e.g., a moderated content category(ies) or a non-moderated content category) corresponding to input content (e.g., video frame, image data). The moderated image detection component 652 may be configured in a similar manner as the moderated image detection component 614. In some embodiments, the moderated image detection component 652 may be configured to detect different moderated content categories than the moderated image detection component 614.

The moderated character detection component 654 may be configured to determine a content category (e.g., a moderated content category(ies) or a non-moderated content category) corresponding to text data included in the video frame or image data. In some cases, the video frame or image data generated by the generative model 640 may include text (e.g., a title or headline, characters in artistic fonts, etc.), and the moderated character detection component 654 may be configured to perform character or text recognition (e.g., optical character recognition or other techniques) to identify the text. The moderated character detection component 654 may be configured to detect similar content categories as the moderated image detection component 652. In example embodiments, the moderated character detection component 654 may include a discriminative model (e.g., classifier machine learning model) configured to determine the content category corresponding to the text. In other embodiments, the moderated character detection component 654 may include a generative model, which may be prompted to identify the content category corresponding to the text. The prompt may include information related to the moderated content categories, for example, a name of the moderated content category, a description (e.g., rules, policies, etc.) of the category, an example(s) of content corresponding to the category, etc.

Based on processing the output image/video data 645, the content moderation component 650 may determine moderation output 660 indicative of the content category corresponding to the output image/video data 645. The moderation output 660 may be based on aggregating or combining category(ies) corresponding to individual video frames, when the output data 645 includes video data. For example, if a threshold number of video frames correspond to a first content category, then the moderation output 660 may include the first content category. As another example, the moderation output 660 may include a list of the content categories determined, without any thresholding of a number of frames the category corresponds to. In some embodiments, the moderation output 660 may include a confidence value representing a likelihood of the output image/video data 645 corresponding to the content category(ies).

The moderation output 660 may be provided to the output routing component 150, which may perform similar operations are described above in relation to FIG. 1.

In some embodiments, a moderated content category may be referred to as a content policy or toxic content policy, depending on system configurations (e.g., which term is used for training the models). In some embodiments, as described herein, the moderated image detection component 652 may receive a prompt. An example of such a prompt includes:
{
Evaluate the text-to-image or text-to-video prompts to determine if it violates any of the following toxic policies:
Animal Abuse
Violence and Gore
Gestures and Profanity
Harmful Misinformation
Hate and Intolerance
Illegal
Non-Violent Criminal Activities
Self-Injury
Nudity or Adult
Stereotype
Toxic Minors
Violent Acts and Actors
Non-policy violating
Or if it asks to generate any legally-protected characters, celebrities.
Prompt: [prompt]
Question: Does this prompt violate any of the above policy? Which policies does it violate? Or If it asks to generate any IP protected characters, celebrities?
}

In cases where a model may receive a prompt to determine whether input content corresponds to a moderated content category, such a prompt may be similar to the above example. In some embodiments, the prompt may include in-context-learning (ICL) information. Another example prompt may include:
{
You are part of a team for content moderation, and your job is to detect whether a user request to generate [text or image or video] violates our policy on antagonism, celebrities or animated characters.
Antagonism promotes hateful content with respect to genders, race, ethnicity, country, communities, cultures and values. Any prompt that promotes or implies discord, hate or animosity between groups is considered antagonistic.
A prompt containing celebrity information such as name or uniquely identifiable information such as associated work, company etc. is to be identified and blocked.
A prompt containing animated character information from cartoons, comic books, games etc.
such as name or uniquely identifiable information such as associated franchise, company etc.
is to be identified and blocked.
Exemplars:
{“request”: “show images of different people in the world”, “output”: “this request does not point to antagonism”}
{“request”: “show images of community that is different from others”, “output”: “this request does point to antagonism”}
{“request”: “Generate an image of the founder of [company]”, “output”: “this request does point to celebrities.”} {“request”: “generate images of a mouse”, “output”: “this request does not point to celebrities.”}
}

As described herein, in some cases where content (e.g., input content, user request, etc.) is determined to correspond to a moderated content category, the system may use (e.g., append) a “core belief” (e.g., data corresponding to the moderated content category) to the prompt (as described in relation to FIG. 5) in order to instruct the generative model 120 (e.g., the core inference model) to respond in alignment with certain content policies or decide to decline responding to the user request. For example, for content corresponding to a bias content category, the core belief appended to the prompt may include “Responses should not include biased opinions with respect to gender, age, race, ethnicity, disabilities. Please respond in a respectful manner.”

As described herein, in some cases where content (e.g., model outputs) is determined to correspond to a moderated content category, the system may “short-circuit” (e.g., cease or stop) processing by the core inference model and/or may “block” (e.g., prevent) output of the model's generated response (e.g., from being returned to the user or a system component for further processing).

As described herein, in some cases where model output is determined to correspond to a moderated content category, the system may re-process (e.g., re-decode) the model output using additional prompt augmentations that may instruct the core inference model to respond in alignment with content policies (e.g., as shown in FIG. 5).

One or more system components, for example, the content moderation model 140, the moderated character detection 654 and other components, may be configured to process multi-lingual content. For example, the content moderation model 140 and/or the moderated character detection 654 may be configured to process inputs including different natural languages (e.g., a first input including English, a second input including Spanish, etc.), and/or may be configured process an (single) input including multiple natural languages (e.g., an input including English and Spanish).

FIG. 7 illustrates further example components included in the system 100 configured to use a language-model based approach to determine an action to be performed in response to a user input and determine a response to be presented to a user 705. As shown in FIG. 7, the system 100 may include a user device 710, local to the user 705, in communication with one or more system component(s) 720 via a network(s) 199. The network(s) 199 may include the Internet and/or any other wide-or local-area network, and may include wired, wireless, and/or cellular network hardware.

In some embodiments, the system component(s) 720 may include various components that may support processing by a language model, such as a language model orchestrator component 730. In example embodiments, the language model orchestrator component 730 may include an initial plan generation component 735, a prompt generation component 740, at least one language model 745, and an action plan generation component 750. The system component(s) 720 may further include an action plan execution component 725 configured to facilitate/cause performance of actions that may be determined by the language model 745. The system component(s) 720 may further include one or more responding components 760 that may perform the actions.

The responding components 760 may be configured to perform an action related to a user input, including, but not limited to retrieving information potentially relevant for determining a response to the user input (e.g., data from a knowledge base, Internet search, database, an application, etc. ; context related to the interaction; relevant exemplars for a prompt to the language model; relevant application programming interfaces (APIs); etc.), operating a user device (e.g., a smart home device such as a TV, lights, a kitchen appliance, etc.), determining a synthesized speech output, or other actions described herein. As shown in FIG. 7, the responding components 760 may include an API retriever component 742 (further described below), a synthesized speech generation (SSG) component 756, one or more skill/app components 754 and other components described herein.

APIs are a way for one program/component to interact with another. API calls are a mechanism by which the program/component interact. An API call, or API command, is a message sent to a system component asking an API to perform an action, provide a service or information, or the like. An API call may be formatted for the particular API and may include a particular command, optionally using particular arguments and argument values. API calls may be used for a variety of purposes, such as controlling other devices (e.g., an API call of turn_on_device (device=“indoor light 1”) corresponds to a command for a component to turn on a device associated with the identifier “indoor light 1”), obtaining information from other components (e.g., an API call of InfoQA.question (“Who is the president of USA?”) corresponds to a command for a component to find and provide an answer to the indicated question), and performing other actions (e.g., generating synthesized speech, searching data sources, etc.). The system 100 may interact with the responding components 760 via API calls.

The language model orchestrator component 730 may be configured to orchestrate processing by the language model 745. In some embodiments, the language model 745 may be configured to perform one or more stages of processing, which may be referred to as a task generation stage, an action (or directive) generation stage, and a response generation stage.

The processing stages may be performed in a particular order. For example, during a first stage of processing, the language model 745 may be tasked with performing task generation to generate a list of tasks to be performed in order to respond to a user input. During a second stage of processing, based on the list of tasks, the language model 745 may be tasked with performing action generation to generate action requests (or directives) for a responding component(s) 760 to perform an action(s) related to the tasks/user input. During a third stage of processing, based on information received from the responding component(s) 760, the language model 745 may be tasked with generating a response to the user input and/or causing a component(s) of the system 100 to perform further action(s). Further details are described herein in relation to FIG. 8.

In some cases, a subset of the stages may be performed. For some user inputs, the language model 745 may only perform the task generation stage and the response generation stage, where a response to a user input is generated by the language model 745 using parametric knowledge. For example, for a user input “What kind of fruit is lemon?”, the language model 745 may determine that the task is to answer the user's question and may generate a response “Lemon is a citrus fruit that grows on tress” based on the model's parameter knowledge learned during configuration/training operations. In such examples, the language model 745 may not determine an action that is to be performed using a system component, such as sending a request for information to a knowledge base (e.g., the language model 745 may respond without using external knowledge).

In some embodiments, the system may use Retrieval-Augmented Generation (RAG) techniques to inform processing of a language model. RAG techniques may involve referencing an authoritative knowledge base or other type of data source outside of the model's training data sources before generating a response by the model. RAG techniques may extend the already powerful capabilities of language models to specific domains, an organization's internal knowledge base, etc., without the need to retrain the model. In some embodiments, information (e.g., relevant facts, up-to-date information, current/trending topics, etc.) from one or more components (e.g., responding component(s) 760) may be provided to the language model 745 and the model may generate an output based on the received information.

In some embodiments, the language model orchestrator component 730 may be configured to orchestrate processing by multiple different language models, where an individual language model may perform one (or more) of the processing stages described above. For example, a first language model may perform task generation, a second language model may perform action generation, and a third language model may perform response generation. In some embodiments, the language models may be different types of models, for example, a first language model may be a text-to-text generative model, a second language model may be a multi-modal generative model, a third language model may be a text-to-speech generative model, etc. In some embodiments, the language models may be different sizes (e.g., number of parameters), may have different processing capabilities, etc.

Some embodiments may enable use of other components, such as plugins, with the language model 745, where the plugins may add functionality and features to the language model capabilities. For example, the plugins may be used to perform mathematical calculations (e.g., a calculator plugin), statistical analysis (e.g., a statistics plugin), natural language translation, speech generation, etc. For further example, the plugins may additionally, or alternatively, be used to perform an action responsive to a user input based on the response generated by the language model. As a further example, the plugins may cause the language model to process and output according to an enabled plugin, which may result in a different response, reasoning, processing, etc. from the language model than when the plugin is not enabled. In some cases, a user or a system may enable a plugin(s) for use with the language model.

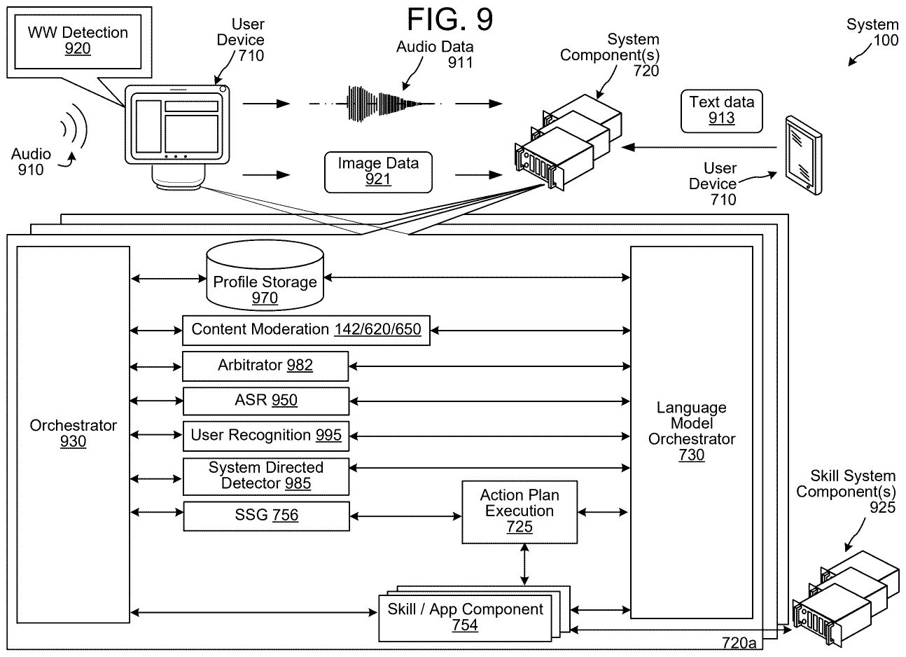

The system component(s) 720 may include other processing components configured to process user inputs and other type of inputs (e.g., sensor data, audio data, data indicative of an event occurring, etc.) received via the user device 710. In example embodiments, the system component(s) 720 may process spoken inputs using ASR processing. The system component(s) 720 may also be configured to process non-spoken inputs, such as gestures, textual inputs, selection of GUI elements, selection of device buttons, etc. The system component(s) 720 may also include other components to understand an input, determine an action to be performed in response to receiving the input, generate an output responsive to the input, and the like. Such other components may perform natural language processing, SSG processing, etc., some of which are described herein in relation to FIG. 9.

As shown in FIG. 7, the system component(s) 720 may receive user input data 727, which may be provided to the language model orchestrator component 730 (as shown in FIG. 8). In some instances, the user input data 727 may include one or more types of data, such as text (e.g., a text or tokenized representation of a user input), audio, image, video, etc. Such data may be encoded/embedded data that represent the underlying type of data (e.g., text, audio, image, etc.). For example, the user input data 727 may include text (or tokenized) data when the user input is a natural language user input. In some embodiments, an ASR component 950 of the system 100 may receive audio data representing a spoken natural language user input from the user 705. The ASR component 950 may perform ASR processing on the audio data to determine ASR data representing the spoken user input, which may correspond to a transcript of the user input. As described herein, with respect to FIG. 9, the ASR component 950 may determine ASR data that includes an ASR N-best list including multiple ASR hypotheses and corresponding confidence scores representing what the user may have said. The ASR hypotheses may include text data, token data, ASR confidence score, etc. as representing the input utterance. The confidence score of each ASR hypothesis may indicate the ASR component's 950 level of confidence that the corresponding hypothesis represents what the user said. The ASR component 950 may also determine token scores corresponding to each token/word of the ASR hypothesis, where the token score indicates the ASR component's 950 level of confidence that the respective token/word was spoken by the user. The token scores may be identified as an entity score when the corresponding token relates to an entity. In some instances, the user input data 727 may include a top scoring ASR hypothesis of the ASR data. As an even further example, in some embodiments, the user input may correspond to an actuation of a physical button, data representing selection of a button displayed on a graphical user interface (GUI), image data of a gesture user input, combination of different types of user inputs (e.g., gesture and button actuation), etc. In such embodiments, the system 100 may include one or more components configured to process such user inputs to generate the text or tokenized representation of the user input (e.g., the user input data 727). As a further example, the user input data 727 may include image data representing information being displayed at the user device 710 (e.g., on-screen context data) when the user 705 provides the user input or at substantially the same time as the user 705 provides the user input. As yet a further example, the user input data 727 may include audio data representing audio signals (e.g., background noise, audio from other devices such as TV, appliances, etc.) occurring in the environment of the user 705 that can be captured by the user device 710 (e.g., audio environment context). As yet a further example, the user input data 727 may include image data representing one or more objects in the environment of the user 705 (e.g., visual environment context). As yet a further example, the system may receive image data including text (and other data), and the user input data 727 may include text determined from the image data using optical character recognition or other techniques.

In some embodiments, the system component(s) 720 may receive input data that may not be provided directly/explicitly by a user. Such other type of input data may be processed in a similar manner as the user input data 727 as described herein. Such other type of input data may be received in response to detection of an event. Example events include change in a device state (e.g., front door opening, garage door closing, TV turned off, thermostat detecting a particular temperature, etc.), occurrence of an acoustic event (e.g., baby crying, appliance beeping, glass breaking, etc.), presence of a user (e.g., a user approaching the user device 710, a user entering the home, etc.), occurrence of an event indicated by a user (e.g., a reminder/notification requested by the user, sporting event score change, start of a TV program, calendar event, etc.), and others. In some embodiments, the system 100 may process the input data and generate a response/output. For example, the input data may be received in response to detection of a user generally or a particular user, an expiration of a timer, a time of day, detection of a change in the weather, a device state change, etc. In some embodiments, the input data may include data corresponding to the event, such as sensor data (e.g., image data, audio data, proximity sensor data, short-range wireless signal data, etc.), a description associated with the timer, the time of day, a description of the change in weather, an indication of the device state that changed, etc. The system 100 may include one or more components configured to process the input data to generate a natural language representation of the input data. The system 100, for example, the language model orchestrator component 730 may process the input data and may cause performance of an action. For example, in response to detecting a garage door opening, the system 100 may cause garage lights to turn on, living room lights to turn on, etc. As another example, in response to detecting an oven beeping, the system 100 may cause a user device 710 (e.g., a smartphone, a smart speaker, etc.) to present an alert to the user. The language model orchestrator component 730 may process the input data to generate tasks (e.g., an action plan) that may cause the foregoing example actions to be performed.

FIG. 8 illustrates example processing of the user input data 727 by the system component(s) 720 using the language model 745. Although the figure and discussion of the present disclosure illustrate certain components and steps in a particular order, the components may be implemented in a different manner (as well as certain components removed or added) and the steps described may be performed in a different order (as well as certain steps removed or added) without departing from the present disclosure.

In some embodiments, the language model 745 may perform iterative processing (e.g., multiple processing cycles, multiple processing stages, etc.) with respect to individual user input data 727. Such iterative processing is illustrated and described herein with respect to FIG. 8. For example, in a first iteration of processing the language model 745 may receive a first prompt from the prompt generation component 740, in response to which the language model 745 may determine one or more tasks to be performed with respect to the user input data 727, then at least one of the determined task(s) may be performed via the action plan execution component 725, the results of the performed task(s) may be provided to the language model 745 via a second prompt, in response to which the language model 745 may determine further tasks to be performed or may determine that a (final) response to the user input is determined.

The initial plan generation component 735 may be configured to determine various information relevant to processing of the user input data 727 by the language model orchestrator component 730. The initial plan generation component 735 may generate an action plan (e.g., action plan for prompt data 826) representing one or more tasks/actions to be performed to determine the various relevant information. The relevant information may be included in a prompt to the language model 745. The initial plan generation component 735 may receive (step 1) the user input data 727 representing a user input from the user 705. Based on the user input data 727, the initial plan generation component 735 may determine information relevant for processing the user input data 727 and may output (step 2) the action plan for prompt data 826. The action plan for prompt data 826 may include one or more tasks to be performed to retrieve the relevant information. The tasks may be represented as action descriptions, API requests/calls, API descriptions, requests to a component(s) (e.g., the responding components 760), and the like. Examples tasks that may be included in the action plan for prompt data 826 may relate to obtaining certain information like context data, user profile data, user preferences, available/relevant exemplars, available/relevant APIs, etc.

In example embodiments, the initial plan generation component 735 may determine one or more types of context data relevant for the user input data 727. Types of context data may include user context (e.g., user location, user profile identifier, user demographics, user profile data, user preferences, personalized catalogs, enabled skills/applications, etc.), device context (e.g., device type, device identifier, device location (e.g., living room, kitchen, office, etc.), device capabilities, device state, etc.), environmental context (e.g., time/date the past user input was received/processed, device that received the user input, device that responded to the user input, objects proximate to the device/user, background audio/noises, state/status of device(s) in the user's environment (e.g., TV is on, thermostat temperature, etc.), dialog context (e.g., prior user inputs of a dialog, prior system responses of the dialog, dialog topic, actions performed during the dialog, etc.), and the like. As an example, if the user input data 727 corresponds to operation of a device (e.g., the user input corresponds to a smart home domain), the initial plan generation component 735 may determine that device context information, in particular device states for the devices associated with the user/user profile of the user 705, may be relevant information. As another example, if the user input data 727 corresponds to output of media, such as music, movies, TV shows, etc., the initial plan generation component 735 may determine that user context information, in particular user preference for media genre associated with the user/user profile of the user 705, may be relevant information.

Based on the type of context data determined to be relevant, the initial plan generation component 735 may output the action plan for prompt data 826 to include a request for the type(s) of context data. For example, if device context is relevant information, then the action plan for prompt data 826 may include an API call/description corresponding to a component (e.g., a device state component, a smart home component, a user profile storage, etc.) capable of providing device information. As another example, if user context is relevant information, then the action plan for prompt data 826 may include an API call/description corresponding to a component (e.g., a user profile storage, a personalized context component, etc.) capable of providing user information.

In some embodiments, the initial plan generation component 735 may determine one or more components or types of components that may be relevant for processing the user input data 727. As an example, if the user input data 727 corresponds to operation of a device (e.g., the user input corresponds to a smart home domain), the initial plan generation component 735 may determine that components (e.g., APIs) corresponding to device operation or smart home domain may be relevant, and the initial plan generation component 735 may output the action plan for prompt data 826 to include device operation components or smart home domain components. As another example, if the user input data 727 corresponds to output of media, the initial plan generation component 735 may determine components corresponding to media output or music domain may be relevant, and the initial plan generation component 735 may output the action plan for prompt data 826 to include media output components or music domain components.

In some embodiments, the initial plan generation component 735 may determine a query to retrieve exemplars and/or APIs relevant for processing the user input data 727 using the language model 745. As used herein, an exemplar refers to information that may be included in a prompt to a language model that provides an example of how the language model is to process or respond, including, among other things, what actions the language model can request performance of. A prompt may include more than one exemplar. Few shot learning or in-context learning by the language model is enabled by including the exemplars in the prompt. The query (or request) to retrieve relevant exemplars and/or APIs may be included in the action plan for prompt data 826. The query (or an API request based on the query) may be processed by the responding component 760 (e.g., an exemplar retriever component, the API retriever component 742, etc.). The query, in some embodiments, may include the user input data 727 or a portion or representation thereof.

The initial plan generation component 735 may employ one or more techniques to determine relevant information or to determine the tasks to obtain relevant information. Examples of such techniques include using one or more of machine learning models (e.g., classifiers), statistical models, rules engines, etc. to determine the relevant information. The initial plan generation component 735 may determine a topic/category corresponding to the user input data 727, a (semantically or lexically) similar past user input and relevant information corresponding to the similar past user input, and the like.

In example embodiments, the initial plan generation component 735 may use a language model to determine the types of information relevant for processing the user input data 727. The initial plan generation component 735 may input a prompt to the language model, for example, “What types of information is relevant for responding to the user input: [user input data 727]”, and the language model may output one or more types of context data, one or more types of components, etc. that may be relevant. In some embodiments, the initial plan generation component 735 may input a prompt to the language model 745 requesting relevant information for the user input data 727.

The action plan for prompt data 826, which includes types of relevant information for the user input data 727 or tasks to be performed to obtain the relevant information, may be processed by the action plan execution component 725 to retrieve the relevant information. The action plan execution component 725 may process the action plan for prompt data 826 to generate one or more requests to perform an action (e.g., API requests 836) for a particular responding component 760. For example, if the action plan for prompt data 826 indicates that device information/context is relevant, then the action plan execution component 725 may generate an API request 836 for a responding component 760a capable of providing the device information, where the API request 836 may include a user profile identifier associated with the user 705, a device identifier associated with the user device 710, and/or other information based on information required in the API call for the responding component 760a.

The API request 836 may be sent (step 3) to the corresponding responding component(s) 760. The responding component(s) 760 may include components that the action plan execution component 725 may communicate with via API requests or other type requests. As shown in FIG. 7, the responding component(s) 760 may include one or more skill/app components 754, the SSG component 756 (e.g., configured to convert input data to audio data representing synthesized speech), and the API retriever 742 (e.g., configured to provide APIs and corresponding information supported by the system 100). The responding component(s) 760 may also include an orchestrator component 930 (e.g., configured to facilitate processing by other system components 720 such as those shown in FIG. 9), a context source component (e.g., configured to provide user context data, device context data, environmental context data, dialog context data, personalized context data, etc.), a multimodal response component (e.g., configured to respond to a user input via outputs in more than one data form), a content moderation component (e.g., configured to moderate certain types of content such as biased content, harmful content, offensive content, etc.), a smart home devices component (e.g., configured to provide device information such as device state, device capabilities, etc.), a language model-based agent (e.g., a component that uses a language model (e.g., a LLM) or other type of generative model to provide information), an exemplar provider component (e.g., configured to respond to a query for relevant exemplars), a knowledge base component (e.g., including one or more knowledge bases or other structured data that can be searched to obtain information), an entity resolution component (e.g., configured to determine specific entities corresponding to entities represented in a user input or language model output), and the like.

In response to receiving the API request 836 (at step 3), the responding component(s) 760 may provide (step 4) an API response(s) 862 to the action plan execution component 725. At step 3, the API request(s) 836 is based on the action plan for prompt data 826, and thus, at step 4, the API response(s) 862 may include information relevant for processing the user input data 727. In examples, the API response(s) 862 may include relevant context information (e.g., device context, user context, environment context, dialog context, personalized context, etc.), relevant APIs and/or API descriptions for processing the user input data (e.g., API(s) for operating devices, API(s) for outputting media content, etc.), relevant exemplars, and other relevant information requested via the action plan for prompt data 826.

In example embodiments, the API request 836 may be sent to the API retriever component 742. In such cases, the API request 836 may include a query to retrieve relevant APIs based on the user input data 727. The API retriever component 742 may be configured to receive a search query and output one or more APIs or API data corresponding to (e.g., satisfying, matching, etc.) the search query. API data may include an API call, an API description, and other information associated with the API. In some embodiments, the API retriever component 742 may include or may be in communication with an index storage 744 (shown in FIG. 7). The index storage 744 may store various information associated with multiple APIs. Examples of information stored in the index storage 744 include: API/component descriptions (e.g., a description of one or more function that the API can be used to perform), API arguments (e.g., parameter inputs, input types, examples of input values, examples of output values, output type, etc.), identifiers for components corresponding to the API (e.g., alphanumerical component ID, component name, etc.), and other information. In some embodiments, the index storage 744 may include other information associated with the API, such as historical accuracy/defect rate, historical latency value, feedback (e.g., user satisfaction/feedback, system-based feedback), etc. The index storage 744 may also include sample user inputs corresponding to the API, where the sample user input may represent a user input for which the API can perform an action for.

The API retriever component 742 may apply one or more retrieval techniques to determine API data corresponding to the search query. For example, the API retriever component 742 may compare one or more APIs included/represented in the index storage 744 to the user input data 727 represented in the search query to determine one or more APIs (top-k list). Such comparison may involve a semantic comparison between the user input data 727 and the API data. In some embodiments, the API retriever component 742 may use a neural-based retrieval technique that may involve determining an encoded representation of the user input/search query and comparing (e.g., using cosine distance) the encoded representation(s) of the API data in the index storage 744. The relevant APIs may be included in the API response 862.

In a non-limiting example, for a user input “book a flight”, the API retriever component 742 may determine one or more API calls corresponding to booking a flight (e.g., Bookflight.location (“departing airport code”, “arrival airport code”), Bookflight.date (“departing date”), bookflight.rountrip (“departing location”, “arrival location”, “departure date”, “return date”), AirlineBookFlight (“departing airport code”, “arrival airport code”), etc.).

Some embodiments may include an exemplar provider component that may operate in a similar manner as the API retriever component 742 in terms of implementing one or more retrieval techniques to determine exemplars corresponding to (e.g., satisfying, matching, etc.) a search query based on the user input data 727. The exemplar provider component may search an index storage including various information related to multiple different exemplars. In some embodiments, the index storage may include sample user inputs associated with an exemplar, and the relevant exemplars may be retrieved based on a comparison of the sample user inputs and the user input data 727. The retrieved exemplars may be included in the API response 862.

The information from the API response(s) 862 may be included in a prompt to the language model 745. The action plan execution component 725 may determine action plan response data 838 based on the API response(s) 862. The action plan execution component 725 may combine (e.g., aggregate, summarize, de-duplicate, etc.) multiple API responses 862 to generate the action plan response data 838. In some examples, the action plan response data 838 may be the same or similar to the API response(s) 862. The action plan execution component 725 may send (step 5) the action plan response data 838 to the prompt generation component 740.

Using the action plan response data 838, the prompt generation component 740 may determine prompt 842 for the language model 745. The prompt 842 may be a natural language input (e.g., a natural language request, a natural language instruction, etc.). In some embodiments, the prompt 842 may include information in a manner that the language model 745 is trained for. The prompt generation component 740 may send (step 6) the prompt 842 to the language model 745, where the prompt 842 may include the user input data 727 (or a representation of the user input data 727) and the relevant information for processing the user input data 727. For example, the prompt 842 (at step 6) may include relevant context data, relevant APIs or API descriptions, etc. that may be included in the action plan response data 838. In some embodiments, the prompt 842 may include a request or directive for the language model 745 to respond to the user input data 727. In some embodiments, the prompt 842 may include one or more exemplars (e.g., in-context learning examples) for processing the user input data 727.

The prompt 842 may include indicators (e.g., labels, specific tokens, etc.) to identify certain information. In example embodiments, the prompt 842 may include a “User” indicator (to indicate that the following string of characters/tokens are the user input), an “Exemplar” indicator (to indicate exemplars), and so on.

In some embodiments, the prompts for the language model described herein may include a request for the language model to output a response that satisfies certain conditions. Such conditions may relate to generating a response that is unbiased (toward protected classes, such as gender, race, age, etc.), non-harmful, profanity-free, etc. For example, prompt data generated by a prompt generation component described herein may include “Please generate a polite, respectful, and safe response and one that does not violate protected class policy.”

In some embodiments, the prompt 842 may include an indication the processing stages (e.g., the task generation stage, the action generation stage, and the response generation stage) that the language model 745 is to perform. In some examples, for the task generation stage, the prompt 842 may direct the language model 745 to generate an output (e.g., tokens) representing the model's interpretation of the user input and/or one or more tasks to be performed to respond to the user input (the model output may be, for example, the user is requesting [intent of the user input], the user wants to [desired user action], need to determine [information needed to properly process the user input], etc.). For the task generation stage, the prompt 842 may also direct the language model 745 to prioritize a list of tasks to be performed, if more than one task is to be performed and select one (or more) task for the current iteration of processing.

In some examples, for the action generation stage, the prompt 842 may direct the language model 745 to generate an output (e.g. tokens) representing an action(s) (or directive(s)) and/or an API call(s) corresponding to the user input, where performance of the action(s) or execution of the API(s) can be done to retrieve information to determine a response to the user's input, perform the user requested action, retrieve information/data to perform other tasks on the task list, etc. In some examples, for the action generation stage, the prompt 842 may direct the language model 745 to process the results of the action(s)/API(s) determined by the language model 745, and to determine whether a response to the user input can be generated or whether there are further tasks to be performed from the task list.

In some examples, for the response generation stage, the prompt 842 may direct the language model 745 to generate an output (e.g., tokens) representing a response (e.g., a final response) to the user input data 727. In examples, the language model 745 may be directed to generate the response based on the results of performing the action(s)/API(s).

The prompt generation component 740 may send (step 6) the prompt 842 to the language model 745, which may process the prompt 842 to generate a language model (LM) response 846. The LM response 846 may be a natural language output generated based on the prompt 842. The LM response 846 may include text tokens. In other embodiments, where the language model 745 may be a multi-modal model, the LM response 846 may include other types of tokens, for example, audio tokens, image tokens, etc.

Based on receiving the prompt 842 at step 6, the language model 745 may generate the LM response 846 at step 7, where the instant LM response 846 may include outputs corresponding to the task generation stage and the action generation stage. The LM response 846 may include an action for determining information relevant to or responsive to the user input data 727. For example, the LM response 846 may include an action to search a knowledge base (e.g., to find a response to a user question), an action to determine information from a particular skill/app or language model-based agent (e.g., to determine current weather information, to determine a cost of an item, to book travel, etc.), an action to operate a device (e.g., turn on lights, set thermostat to a particular temperature, etc.), an action to request information from the user 705, etc.

In some embodiments, the LM response 846 may include an API or API description corresponding to the determined action. For example, the LM response 846 may include an API to operate a device or an API call(s) to output media content. The language model 745 may determine the actions and/or the API information based on the relevant APIs included in the prompt 842. The language model 745 may generate actions and/or API information that is not based on (e.g., correspond to, is similar to, etc.) the relevant APIs included in the prompt 842 (for example, the language model 745 may generate incorrect/unsupported actions and/or API information).

The LM response 846 may follow the format included in the prompt 842 or that the language model 745 is trained to follow. An example prompt 842 may be:
{
Please process the following user input and context data to determine at least one action or API to execute and generate a response to the user.
First determine a task to perform (use “Task” label), then determine an API to perform the task (use “Action” label), then process the results from the API, and then generate a response to the user input (use “Response” label). You may determine multiple tasks to perform. You may have to process iteratively.
User: Turn on living room TV
Available context:
   User devices: “living room TV”=[device id]
   “living room TV” device state=Off
Available APIs:
   TurnOn. device (device)
   TurnVolumeUp. device (device)
   SetTVChannel (device, input channel)
}
Based on processing the above example prompt 842, an example LM response 846 (at step 7) may be:
{
Task: User wants to turn on living room TV that is operation of a user device.
Action: I need an API to operate a device. TurnOn. device (device =“living room TV”)
}

The LM response 846 may be sent (step 7) to the action plan generation component 750, which may determine action plan data 852. As described herein, the language model 745 may generate tokens in sequence, as such, the language model 745 may generate portions of the LM response 846 in a tokens-by-tokens basis. In some embodiments, the LM response 846 may be processed by the action plan generation component 750 based on the language model 745 generating the tokens representing the action or corresponding to the action generation stage.

The action plan generation component 750 may process the LM response 846 to identify one or more actions/APIs generated by the language model 745. In examples, the action plan generation component 750 may parse the tokens/text included in the LM response 846 to extract tokens/text representing an action or API. In some embodiments, the action plan generation component 750 may be configured to determine one or more components (e.g., responding components 760a-n) configured to perform the identified action or API. Based on the LM response 846, the action plan generation component 750 may determine the action plan data 852, which may in turn cause performance of an action (e.g., execution of API calls) to determine a potential responses(s) to the user input. The action plan data 852 may include one or more APIs to be executed, where the APIs may be determined based on (e.g., extracted from) the LM response 846. For example, if the LM response 846 includes an action of “determine weather forecast for today” or an API call of “GetWeather. location ([city])”, then the action plan generation component 750 may determine the action plan data 852 to include an API call “GetWeather. location ([city])” and include an identifier for the responding component(s) 760a (e.g., a weather skill component). Instead of or in addition to an API call, the action plan data 852 may include a request to perform an action, an API description, etc. In some embodiments, the action plan generation component 750 may determine the responding components 760 based on user permissions, subscriptions, authorization or other use-enabling information associated with the user 705 (e.g., included in user profile data).

In some embodiments, the action plan generation component 750 may be configured to determine more than one responding component 760 to perform the action/execute the API indicated in the LM response 846. In some embodiments, the action plan generation component 750 may determine APIs corresponding to multiple responding components 760. For example, for the “GetWeather. location ([city])” API, the action plan data 852 may include an identifier for a first weather skill component, an identifier for a second weather skill component, an identifier for a search engine component, etc.

The action plan data 852 may be sent (step 8) to the action plan execution component 725. The action plan execution component 725 may identify the APIs in the action plan data 852 and generate executable API calls for the corresponding responding components 760. Based on the action plan data (received at step 8), the action plan execution component 725 may generate an additional (a second) API request (or multiple API requests) 836. The (additional/second) API request(s) 836 may be sent (step 9) to the responding component(s) 760. For example, the action plan execution component 725 may send a first API call to a first responding component 760a and a second API call to a second responding component 760b.

In some cases, the action plan data 852 may include incomplete API calls and the action plan execution component 725 may be configured to generate executable API calls (e.g., complete API calls) corresponding to the action plan data 852.

The action plan execution component 725 may generate one or more executable API calls including one or more parameters using information included in the action plan data 852 and/or various other contextual information (e.g., speaker recognition results, a user ID, user profile information (e.g., age, gender, location, language, geographic marketplace, etc.), device ID, device profile information, device state indicators, a dialog history, and/or a interaction history associated with the user and/or the device, etc.). In some embodiments, the various contextual information may be contextual information not provided to the language model orchestrator component 730. Prior to generating the executable commands, the action plan execution component 725 may modify (e.g., remove, filter, preempt, etc.) a directive included in the action plan data 852 that is determined to be in conflict with a system operating policy. The action plan execution component 725 may generate one or more additional executable commands corresponding to directives not included in the action plan data 852.

In response to receiving the API request(s) 836 (at step 9), the responding component(s) 760 may send (step 10) an (additional/second) API response(s) 862 to the action plan execution component 725. The action plan execution component 725 may determine (additional/second) action plan response data 838 based on the (additional/second) API response(s) 862. The action plan execution component 725 may combine (e.g., aggregate, summarize, de-duplicate, etc.) multiple API responses 862 to generate the action plan response data 838. In some examples, the action plan response data 838 may be the same or similar to the API response(s) 862. In some examples, the action plan response data 838 may include an identifier associated with the responding component 760 that provided the API response 862. For example, the (additional/second) action plan response data 838 may include first weather information from a first weather skill component, second weather information from a second weather skill component, third weather information from a search engine component, etc. In some embodiments, the action plan execution component 725 may remove/filter information from the API response 862 that is determined to include information not beneficial to the processing by the language model 745.

The action plan execution component 725 may send (step 11) the (additional/second) action plan response data 838 to the prompt generation component 740. The information from the API response(s) 862 may be included, by the prompt generation component 740, in a (additional/second) prompt to the language model 745. The prompt generation component 740 may generate the second prompt 842 to include the action plan response data 838 or a representation thereof. The second prompt 842 may also include information from the prior/first prompt (from step 6). For example, the second prompt 842 may include the user input data 727 (or a representation thereof), the relevant information for processing the user input data 727 (e.g., relevant context data, relevant API information, relevant exemplars, etc.), the processing stages information, and the action plan response data 838 (from step 11). In some embodiments, the second prompt 842 may also include at least a portion of the LM response 846 generated during a prior iteration of processing (e.g., the outputs based on performing the task generation stage and the action generation stage) to indicate actions/results of the prior iteration of processing by the language model 745. The second prompt 842 may include an indicator (e.g., label, identifier, etc.) associated with the action plan response data 838 to indicate, to the language model 745, that the string of characters/tokens following the indicator represent information determined based on performance of the actions determined during the action generation stage.

The second prompt 842 may be sent (step 12) to the language model 745 for processing. At this point, the language model 745 may perform the action generation stage of processing the results of the performed actions, which may involve interpreting or understanding the results included in the action plan response data 838. The language model 745 may generate (step 13) a (additional/second) LM response 846 based on the second prompt 842. The second prompt 842 may include a request or directive to the language model 745 to perform further processing with respect to the user input data 727. As described above, the second prompt 842 may provide, among other things, responses/results of performance of the action determined by the language model 745 determined during the prior iteration of processing. The language model 745 may generate further actions to be performed to respond to the user input data 727 (as part of the action generation stage) or may generate a (final/user-facing) response to the user input data 727 (as part of the response generation stage).

An example second prompt 842 may be:
{
Please process the following user input and context data to determine at least one action or API to execute and generate a response to the user.
First determine a task to perform (use “Task” label), then determine an API to perform the task (use “Action” label), then process the results from the API, and then generate a response to the user input (use “Response” label). You may determine multiple tasks to perform. You may have to process iteratively.
   User: Turn on living room TV
Available context:
   User devices: “living room TV” =[device id]
   “living room TV” device state =Off
Available APIs:
   TurnOn.device (device)
   TurnVolumeUp.device (device)
   SetTVChannel (device, input channel)
Prior Iteration:
   Action: TurnOn.device (device =“living room TV”)
TurnOn.device (device =“living room TV”); API response: “living room TV” device state=ON
   }

Based on the above example prompt 842, an example LM response 846 may be:
{
Task: User wants to turn on living room TV that is operation of a user device.
Action: I need an API to operate a device. TurnOn. device (device =“living room TV”)
Action result is “living room TV” device state =ON
Response: The living room TV is on now. Can I help you with anything else?
}

As described herein, the language model 745 may generate the LM response 846 on tokens-by-tokens basis. As such, in some examples, the second LM response 846 may include additional tokens (e.g., newly generated tokens) to the first LM response 846 (from step 7). In other examples, the second LM response 846 may include different tokens than the first LM response 846, where the currently generated tokens may represent outputs for further steps of the action generation stage and/or the response generation stage.

The language model 745 may determine further actions/APIs to be performed in a similar manner as described above. Such further actions/APIs may be based on any tasks, included in the task list generated during the task generation stage, that are still to be performed (e.g., a first task of booking a flight may be done, now a second task of booking a hotel is to be performed). Additionally or alternatively, the further actions/APIs may be based on the results included in the action plan response data 838 (at step 11) (e.g., an API response from a responding component 760 may indicate that additional information is needed to perform an action).

The language model 745 may determine a (final) response to the user input, where the response is to be presented to the user 705 via the user device 710. In other cases, the response may be presented via another user device 710 associated with the user 705. The language model 745 may determine the final response based on the results included in the action plan response data 838 (from step 11). For example, the language model 745 may summarize the results, may combine the results, may generate an interpretation of the results, etc. In a non-limiting example, the language model 745 may combine weather information from two or more responding components (e.g., combine high/low temperature information from a first responding component with humidity information from a second responding component). In another non-limiting example, the language model 745 may interpret results from a knowledge base component to determine a response to the specific user query (e.g., from a biographical search result for a historical person, a birthplace and siblings information may be extracted to determine a response to a user query “tell me about [person's] childhood”).

In some examples, the language model 745 may generate the further action to be performed is requesting additional information from the user 705. Such further action, in some embodiments, may be labeled as “Response” so that the action plan generation component 750 may cause a request to be output to the user 705.

The second LM response 846 may be sent (step 13) to the action plan generation component 750, which may determine (step 14) the (additional/second) action plan data 852. In some examples, the second LM response 846 sent to the action plan generation component 750 may include further action(s)/API(s) to be executed, which may be labeled with “Action.” In some examples, the second LM response 846 may include a final response to the user input, which may be labeled with “Response.”

Based on the tokens corresponding to the “Action” label, the action plan generation component 750 may determine the action plan data 852 to include one or more actions, one or more API calls and/or one or more responding components 760 corresponding to the action(s)/API(s) determined by the language model 745.

Based on the tokens corresponding to the “Response” label, the action plan generation component 750 may determine the action plan data 852 to include one or more actions, one or more API calls and/or one or more responding components 760 to present the output tokens to the user 705 as a response to the user input. For example, the action plan data 852 may include an identifier for the SSG component 756 to cause the output tokens, generated by the language model 745, to be presented as synthesized speech. As another example, the action plan data 852 may include an identifier for the responding component 760 capable of generating outputs in more than one form (e.g., a multi-modal output component) to cause the tokens to be presented as synthesized speech, displayed text/graphics, and/or other types of outputs.

The (second) action plan data 852 may be sent (step 14) to the action plan execution component 725, and as described herein, the action plan execution component 725 may determine executable API calls based on the action plan data 852. If the action plan data 852 represents additional actions to be performed, then the action plan execution component 725 may cause the corresponding responding component(s) 760 to perform the additional action(s) and corresponding response(s) (e.g., API responses 862) may be communicated to the prompt generation component 740 (via the action plan execution component 725 and action plan response data 838) to initiate another iteration of processing by the language model 745 with respect to the user input data 727. If the action plan data 852 represents a response to be presented to the user 705, then the action plan execution component 725 may cause the corresponding responding component(s) 760 to determine output data (e.g., responsive output data 762 shown in FIG. 7) that may be presented via the user device 710. For example, the responsive output data 762 may be sent to the user device 710 via the orchestrator component 930 or another system component(s) 720 (described in relation to FIG. 9).

In some embodiments, when further actions are generated by the language model 745 to be performed with respect to the user input data 727, the language model orchestrator 730 may perform another iteration of processing, which may involve generating another prompt 842 to the language model 745, generating another LM response 846 that may be used to determine further action plan data 852. The language model 745 may generate tokens corresponding to the action generation stage and/or the response generation stage during the further iteration.

In some embodiments, when a final response is generated by the language model 745, further processing with respect to the user input data 727 by the language model orchestrator 730 may be ceased (e.g., processing with respect to the user input data 727 by the language model orchestrator 730 may be complete). The language model orchestrator 730 may process with respect to a subsequently received user input, which may or may not be part of the same dialog session as the prior/already processed user input data 727.

The responsive output data 762 may include one or more of output audio data representing synthesized speech, text data for display, image for display, graphics/icons for display, media (e.g., video, music, background music, notification sounds, etc.) for playback, and other data. In some embodiments, the responsive output data 762 may include placement information representing where (e.g., top banner, left portion, center of screen, overlay on current visual, etc.) on the display screen of the user device 710 the output data is to be displayed. In some embodiments, the responsive output data 762 may be determined/provided by the responding component 760. In some embodiments, another system component 720 may process the responsive output data 762 prior to sending to the user device 710 to ensure that the responsive output data is formatted for the particular user device 710.

Referring again to FIG. 7, as shown, the system component(s) 720 may include a compliance component 770. In some embodiments, the compliance component 770 may be included in the language model orchestrator component 730. In other embodiments, the compliance component 770 may be one of the responding components 760 and the action plan generation component 750 may cause the action plan execution component 725 to send an API request to the compliance component 770 when processing by the compliance component 770 is to be performed.

The compliance component 770 may be configured to determine whether an output of the language model 745 is appropriate for output to the user 705. In some embodiments, the compliance component 770 may be configured to process language model output (e.g., the LM response 846) representing outputs/tokens generated by the language model 745 during processing of the user input data 727. The model output may include tokens generated during the task generation stage, the action generation stage or the response generation stage. The compliance component 770 may also or instead determine whether an input to the language model 745 (e.g., a user request, an output of another system component of the system 100) is appropriate and/or that the input will result in the language model 745 generating an output that is appropriate to present to the user 705. For this determination, the compliance component 770 may process the user input data 727 or a portion or representation thereof. In some embodiments, the compliance component 770 may process other data (e.g., context data, user profile data, system configuration/policy data, etc.) to determine whether the generated response and/or the input is appropriate.

In some embodiments, the compliance component 770 may determine whether the model output/LM response 846 and/or the user input data 727 corresponds to training data used to configure the language model 745 (e.g., the model output or user input is semantically or lexically similar to the training data, the model output or user input corresponds to functionality (e.g., topics, categories, actions, etc.) that the model is trained for, etc.). Additionally or alternatively, the compliance component 770 may determine whether the model output/LM response 846 and/or the user input data 727 corresponds to one or more words or phrases determined to be confidential, sensitive, or offensive. Additionally or alternatively, the compliance component 770 may determine whether the user input or the model output corresponds to an inappropriate content category, which may include biased content (e.g., biased toward protected classes including gender, race, age, etc.), harmful content (e.g., violent content, self-harm, etc.), profanity, etc.

In some embodiments, the compliance component 770 may use one or more techniques to determine whether the model output or the user input is appropriate; such techniques may include a rules-engine, a word-based similarity determination, a machine learning model based determination (e.g., using a classifier to classify model output or user input to appropriate category or inappropriate category), etc.

In some embodiments, the compliance component 770 may process the user input data 727 when it is received by the language model orchestrator component 730 and in some cases may process in parallel to the language model orchestrator component 730. In some embodiments, the compliance component 770 may process the model output as the language model 745 generates the output tokens. In other embodiments, the compliance component 770 may process the model output after the language model 745 has generated tokens for a particular processing stage (e.g., after the task generation stage is completed, after the action generation stage is completed, after the response generation stage is completed, etc.).

In some embodiments, the compliance component 770 may include the content moderation component 142 (or a similarly configured component), which may process portions of the LM response 846 as the portions are generated by the language model 745. In some embodiments, the content moderation component 142 may only process user-facing responses (e.g., generated during the response generation stage) and may not process intermediate outputs (e.g., including task generation and action generation stages). In some embodiments, the content moderation component 142 may process the action plan data 852. In some embodiments, the compliance component 770 may include the belief augmentation component 510 (or a similarly configured component), which may process the user input data 727. In some embodiments, the compliance component 770 may include other content moderation components, such as the components 620 and 650.

If the compliance component 770 determines that the model output or the user input data 727 is appropriate, then the language model orchestrator component 730 may continue processing with respect to the user input data 727. If the compliance component 770 determines that the model output is not appropriate, then one or more remedial actions may be performed. One example remedial action may involve prompting the language model 745 to generate a new/modified model output. In such examples, additional prompt data may be determined, which may include the original prompt data, the initial model output, and an indication that the initial model output is not appropriate for output to the user 705. The additional prompt data may include a request or directive to the language model 745 to generate model output that is appropriate for output to the user 705. Another example remedial action may involve the system outputting a generic/template response (e.g., “Sorry, I can't help you with that” or “I cannot answer questions for [inappropriate category])”) or a request for a rephrased input (e.g., “can you rephrase that”).

In some embodiments, the compliance component 770 may cause the system to output a response indicating where (e.g., a source external to the system components 720) the included/outputted information may be found. For example, the response may include an indication of a source of the training data or the data (e.g., API response 862) that the response is based on (e.g., the indication may include a description of an owner of the intellectual property rights corresponding to the training data/the response information, a hyperlink to the source, etc.). In some embodiments the compliance component 770 may determine that the model generated response is based on (e.g., summarizing, using, similar to, etc.) data that protected by intellectual property rights (or other laws), and instead of outputting the language model generated response (e.g., LM response 846). In some embodiments the responsive output data 762 may include an indication of the intellectual property rights owner, may include access to a source of the data (e.g., website link), or may include a template response (e.g., “I cannot process this request” or “The requested data is protected by intellectual property rights”, etc.). In some embodiments, the compliance component 770 may determine that the user input data 727 involves processing data or outputting data that is protected by certain intellectual property rights (or other laws). An example of such a user input may be “write a story about [protected character]” or “draw an image of [protected character] doing [some action]”, where the owner of intellectual property rights in the [protected character] may not allow use, copying, or other operations. In response, the system may cease or prevent processing by the language model orchestrator 730 of the user input data 727, and the system may output a template response (e.g., “I cannot process this request” or “The requested data is protected by intellectual property rights”, etc.).

As shown in FIG. 7, the system component(s) 720 may include a personalized context component 765. In some embodiments, the personalized context component 765 may be included in the language model orchestrator component 730. In other embodiments, the personalized context component 765 may be one of the responding components 760 and the action plan generation component 750 may cause the action plan execution component 725 to send an API request to the personalized context component 765.

The personalized context component 765 may be configured to determine personalized context data including context data corresponding to the user input data 727 and/or the user 705. In some embodiments, the initial plan generation component 735 may request personalized context data to include in the prompt 842. In other embodiments, other system component(s) 720, such as the language model 745, may request personalized context data (e.g., to determine a personalized response to a user input). The personalized context data may include user preferences, past user inputs, past system outputs for past user inputs from the user 705, past skill/app usage, user-defined items, etc. The personalized context component 765 may infer user preferences from user-provided preferences, past user interactions by the user 705, information related to users similar to the user 705, etc. In some embodiments, the personalized context component 765 may employ one or more techniques to determine the personalized context data; such techniques may include using a rules-engine, using one or more machine learning models (including a generative model), topic determination techniques, neural retrieval search techniques, etc.

In examples, the personalized context component 765 may receive the user input data 727, task data representing a current task being performed/processed, and/or model output indicating that an ambiguity exists or additional information is needed to generate a response to the user input. The personalized context component 765 may receive a query in some examples, which may include an identifier for the user 705. In a non-limiting example, the personalized context component 765 may receive the following example requests: “Does the user prefer to use [Music Service 1] or [Music Service 2] for playing music,” or “What kind of music does the user like?” The personalized context component 765 determine example personalized context data including “The user prefers [Music Service 1]” or “The user likes [music genre]”).

Further information related to the SSG component 756 and the skill/app component 754 is described herein in relation to FIG. 9.

In some embodiments, the language model 745 may be fine-tuned to perform a particular task(s). Fine-tuning of the language model(s) may be performed using one or more techniques. One example fine-tuning technique is transfer learning that involves reusing a pre-trained model's weights and architecture for a new task. The pre-trained model may be trained on a large, general dataset, and the transfer learning approach allows for efficient and effective adaptation to specific tasks. Another example fine-tuning technique is sequential fine-tuning where a pre-trained model is fine-tuned on multiple related tasks sequentially. This allows the model to learn more nuanced and complex language patterns across different tasks, leading to better generalization and performance. Yet another fine-tuning technique is task-specific fine-tuning where the pre-trained model is fine-tuned on a specific task using a task-specific dataset. Yet another fine-tuning technique is multi-task learning where the pre-trained model is fine-tuned on multiple tasks simultaneously. This approach enables the model to learn and leverage the shared representations across different tasks, leading to better generalization and performance. Yet another fine-tuning technique is adapter training that involves training lightweight modules that are plugged into the pre-trained model, allowing for fine-tuning on a specific task without affecting the original model's performance on other tasks. Some techniques may involve supervised fine-tuning (SFT), unsupervised fine-tuning, semi-supervised fine-tuning, or other types of learning.

In some embodiments, one or more of the system components 720 described herein may be configured to begin processing with respect to data as soon as the data or a portion of the data is available to the components (e.g., processing in a streaming fashion). Some system components may be generative components/models that can begin processing with respect to portions of data as they are available, instead of waiting to initiate processing after the entirety of data is available. For example, the language model 745 may start processing a first portion of the prompt 842 while the prompt generation component 740 determines a second/subsequent portion of the prompt 842. As another example, the action plan generation component 750 may start processing a first portion of the LM response 846 while the language model 745 is generating a second/subsequent portion of the LM response 846.

The system 100 may operate using various components as described in FIG. 9. The various components may be located on same or different physical devices. Communication between various components may occur directly or across a network(s) 199. The user device 710 may include audio capture component(s), such as a microphone or array of microphones of a user device 710, captures audio 910 and creates corresponding audio data. Once speech is detected in audio data representing the audio 910, the user device 710 may determine if the speech is directed at the user device 710/system component(s). In at least some embodiments, such determination may be made using a wakeword detection component 920. The wakeword detection component 920 may be configured to detect various wakewords. In at least some examples, each wakeword may correspond to a name of a different digital assistant. An example wakeword/digital assistant name is “Alexa.” In another example, input to the system may be in form of text data 913, for example as a result of a user typing an input into a user interface of user device 710. Other input forms may include indication that the user has pressed a physical or virtual button on user device 710, the user has made a gesture, etc. The user device 710 may also capture images using camera(s) of the user device 710 and may send image data 921 representing those image(s) to the system component(s). The image data 921 may include raw image data or image data processed by the user device 710 before sending to the system component(s). The image data 921 may be used in various manners by different components of the system to perform operations such as determining whether a user is directing an utterance to the system, interpreting a user command, responding to a user command, etc. In some embodiments, the user input data 727 (described in relation to FIG. 7) may include one or more the audio 910, the audio data 911, the text data 913 and the image data 921.

The wakeword detection component 920 of the user device 710 may process the audio data, representing the audio 910, to determine whether speech is represented therein. The user device 710 may use various techniques to determine whether the audio data includes speech. In some examples, the user device 710 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the user device 710 may implement a classifier configured to distinguish speech from background noise. The classifier may be implemented by techniques such as linear classifiers, support vector machines, and decision trees. In still other examples, the user device 710 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 910, is analyzed to determine if specific characteristics of the audio data match preconfigured acoustic waveforms, audio signatures, or other data corresponding to a wakeword.

Thus, the wakeword detection component 920 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 920 may be built on deep neural network (DNN)/recursive neural network (RNN) structures directly, without HMM being involved. Such an architecture may estimate the posteriors of wakewords with context data, either by stacking frames within a context window for DNN, or using an RNN. Follow-on posterior threshold tuning or smoothing is applied for decision making. Other techniques for wakeword detection, such as those known in the art, may also be used.

Once the wakeword is detected by the wakeword detection component 920 and/or input is detected by an input detector, the user device 710 may “wake” and begin transmitting audio data 911, representing the audio 910, to the system component(s) 720. The audio data 911 may include data corresponding to the wakeword; in other embodiments, the portion of the audio corresponding to the wakeword is removed by the user device 710 prior to sending the audio data 911 to the system component(s) 720. In the case of touch input detection or gesture-based input detection, the audio data may not include a wakeword.

In some implementations, the system 100 may include more than one system component(s). The system component(s) 720 may respond to different wakewords and/or perform different categories of tasks. Each system component(s) may be associated with its own wakeword such that speaking a certain wakeword results in audio data be sent to and processed by a particular system. For example, detection of the wakeword “Alexa” by the wakeword detection component 920 may result in sending audio data to system component(s) 720a for processing while detection of the wakeword “Computer” by the wakeword detector may result in sending audio data to system component(s) 720b for processing. The system may have a separate wakeword and system for different skills/systems (e.g., “Castle Adventure” for a game play skill/system component(s) 720c) and/or such skills/systems may be coordinated by one or more skill component(s) 754 of one or more system component(s) 720.

The user device 710/system component(s) 720 may also include a system directed input detector 985. The system directed input detector 985 may be configured to determine whether an input to the system (for example speech, a gesture, etc.) is directed to the system or not directed to the system (for example directed to another user, etc.). The system directed input detector 985 may work in conjunction with the wakeword detection component 920. If the system directed input detector 985 determines an input is directed to the system, the user device 710 may “wake” and begin sending captured data for further processing. If data is being processed the user device 710 may indicate such to the user, for example by activating or changing the color of an illuminated output (such as a light emitting diode (LED) ring), displaying an indicator on a display (such as a light bar across the display), outputting an audio indicator (such as a beep) or otherwise informing a user that input data is being processed. If the system directed input detector 985 determines an input is not directed to the system (such as a speech or gesture directed to another user) the user device 710 may discard the data and take no further action for processing purposes. In this way the system 100 may prevent processing of data not directed to the system, thus protecting user privacy. As an indicator to the user, however, the system may output an audio, visual, or other indicator when the system directed input detector 985 is determining whether an input is potentially device directed. For example, the system may output an orange indicator while considering an input and may output a green indicator if a system directed input is detected. Other such configurations are possible.

Upon receipt by the system component(s) 720, the audio data 911 may be sent to an orchestrator component 930 and/or the language model orchestrator component 730. The orchestrator component 930 may include memory and logic that enables the orchestrator component 930 to transmit various pieces and forms of data to various components of the system, as well as perform other operations as described herein. In some embodiments, the orchestrator component 930 may optionally be included in the system component(s) 720. In embodiments where the orchestrator component 930 is not included in the system component(s) 720, the audio data 911 may be sent directly to the language model orchestrator component 730. Further, in such embodiments, each of the components of the system component(s) 720 may be configured to interact with the language model orchestrator component 730, the action plan execution component 725, the API provider component, and/or other component(s).

In some embodiments, the system component(s) 720 may include an arbitrator component 982, which may be configured to determine whether the orchestrator component 930 and/or the language model orchestrator component 730 are to process with respect to user input data. In some embodiments, the language model orchestrator component 730 may be selected to process with respect to the audio data 911 only if the user 705 associated with the audio data 911 (or the user device 710 that captured the audio 910) has previously indicated that the language model orchestrator component 730 may be selected to process with respect to user inputs received from the user 705.

In some embodiments, the arbitrator component 982 may determine the orchestrator component 930 and/or the language model orchestrator component 730 are to process with respect to the audio data 911 based on metadata associated with the audio data 911. For example, the arbitrator component 982 may be a classifier configured to process a natural language representation of the audio data 911 (e.g., output by the ASR component 950) and classify the corresponding user input as to be processed by the orchestrator component 930 and/or the language model orchestrator component 730. For further example, the arbitrator component 982 may determine whether the device from which the audio data 911 is received is associated with an indicator representing the audio data 911 is to be processed by the orchestrator component 930 and/or the language model orchestrator component 730. As an even further example, the arbitrator component 982 may determine whether the user (e.g., determined using data output from the user recognition component 995) from which the audio data 911 is received is associated with a user profile including an indicator representing the audio data 911 is to be processed by the orchestrator component 930 and/or the language model orchestrator component 730. As another example, the arbitrator component 982 may determine whether the audio data 911 (or the output of the ASR component 950) corresponds to a request representing that the audio data 911 is to be processed by the orchestrator component 930 and/or the language model orchestrator component 730 (e.g., a request including “let's chat” may represent that the audio data 911 is to be processed by the language model orchestrator component 730).

In some embodiments, if the arbitrator component 982 is unsure (e.g., a confidence score corresponding to whether the orchestrator component 930 and/or the language model orchestrator component 730 is to process is below a threshold), then the arbitrator component 982 may send the audio data 911 to both of the orchestrator component 930 and the language model orchestrator component 730. In such embodiments, the orchestrator component 930 and/or the language model orchestrator component 730 may include further logic for determining further confidence scores during processing representing whether the orchestrator component 930 and/or the language model orchestrator component 730 should continue processing, as is discussed further herein below.

The arbitrator component 982 may send the audio data 911 to an ASR component 950. In some embodiments, the component selected to process the audio data 911 (e.g., the orchestrator component 930 and/or the language model orchestrator component 730) may send the audio data 911 to the ASR component 950. The ASR component 950 may transcribe the audio data 911 into text data. The text data output by the ASR component 950 represents one or more than one (e.g., in the form of an N-best list) ASR hypotheses representing speech represented in the audio data 911. The ASR component 950 interprets the speech in the audio data 911 based on a similarity between the audio data 911 and pre-established language models. For example, the ASR component 950 may compare the audio data 911 with models for sounds (e.g., acoustic units such as phonemes, senons, phones, etc.) and sequences of sounds to identify words that match the sequence of sounds of the speech represented in the audio data 911. The ASR component 950 sends the text data generated thereby to the arbitrator component 982, the orchestrator component 930, and/or the language model orchestrator component 730. In instances where the text data is sent to the arbitrator component 982, the arbitrator component 982 may send the text data to the component selected to process the audio data 911 (e.g., the orchestrator component 930 and/or the language model orchestrator component 730). The text data sent from the ASR component 950 to the arbitrator component 982, the orchestrator component 930, and/or the language model orchestrator component 730 may include a single top-scoring ASR hypothesis or may include an N-best list including multiple top-scoring ASR hypotheses. An N-best list may additionally include a respective score associated with each ASR hypothesis represented therein.

In some embodiments, the orchestrator component 930 may cause a NLU component (not shown) to perform processing with respect to the ASR data generated by the ASR component 950. The NLU component may attempt to make a semantic interpretation of the phrase(s) or statement(s) represented in the ASR data input therein by determining one or more meanings associated with the phrase(s) or statement(s) represented in the text data. The NLU component may determine an intent representing an action that a user desires be performed and may determine information that allows a device (e.g., the device 710, the system component(s) 720, a skill/app component 754, a skill system component(s) 925, etc.) to execute the intent. For example, if the ASR data corresponds to “play the 5th Symphony by Beethoven,” the NLU component may determine an intent that the system output music and may identify “Beethoven” as an artist/composer and “5th Symphony” as the piece of music to be played. For further example, if the ASR data corresponds to “what is the weather,” the NLU component may determine an intent that the system output weather information associated with a geographic location of the device 710. In another example, if the ASR data corresponds to “turn off the lights,” the NLU component may determine an intent that the system turn off lights associated with the device 710 or the user 705. However, if the NLU component is unable to resolve the entity—for example, because the entity is referred to by anaphora such as “this song” or “my next appointment”—the system can send a decode request to another speech processing system for information regarding the entity mention and/or other context related to the utterance. The natural language processing system may augment, correct, or base results data upon the ASR data as well as any data received from the system.

The NLU component may return NLU results data (which may include tagged text data, indicators of intent, etc.) back to the orchestrator component 930. The orchestrator component 930 may forward the NLU results data to a skill component(s) 754. If the NLU results data includes a single NLU hypothesis, the NLU component and the orchestrator component 930 may direct the NLU results data to the skill component(s) 754 associated with the NLU hypothesis. If the NLU results data includes an N-best list of NLU hypotheses, the NLU component and the orchestrator component 930 may direct the top scoring NLU hypothesis to a skill component(s) 754 associated with the top scoring NLU hypothesis. The system may also include a post-NLU ranker which may incorporate other information to rank potential interpretations determined by the NLU component.

In some embodiments, after determining that the orchestrator component 930 and/or the language model orchestrator component 730 should process with respect to the user input, the arbitrator component 982 may be configured to periodically determine whether the orchestrator component 930 and/or the language model orchestrator component 730 should continue processing with respect to the user input. For example, after a particular point in the processing of the orchestrator component 930 (e.g., after performing NLU, prior to determining a skill component 754 to process with respect to the user input, prior to performing an action responsive to the user input, etc.) and/or the language model orchestrator component 730 (e.g., after selecting a task to be completed, after receiving the action response data from the one or more components, after completing a task, prior to performing an action responsive to the user input, etc.) the orchestrator component 930 and/or the language model orchestrator component 730 may query the arbitrator component 982 has determined that the orchestrator component 930 and/or the language model orchestrator component 730 should halt processing with respect to the user input. As discussed above, the system 100 may be configured to stream portions of data associated with processing with respect to a user input to the one or more components such that the one or more components may begin performing their configured processing with respect to that data as soon as it is available to the one or more components. As such, the arbitrator component 982 may cause the orchestrator component 930 and/or the language model orchestrator component 730 to begin processing with respect to a user input as soon as a portion of data associated with the user input is available (e.g., the ASR data, context data, output of the user recognition component 995. Thereafter, once the arbitrator component 982 has enough data to perform the processing described herein above to determine whether the orchestrator component 930 and/or the language model orchestrator component 730 is to process with respect to the user input, the arbitrator component 982 may inform the corresponding component (e.g., the orchestrator component 930 and/or the language model orchestrator component 730) to continue/halt processing with respect to the user input at one of the logical checkpoints in the processing of the orchestrator component 930 and/or the language model orchestrator component 730.

A skill system component(s) 925 may communicate with a skill/app component(s) 754 within the system component(s) 720 directly with the orchestrator component 930 and/or the action plan execution component 725, or with other components. A skill system component(s) 925 may be configured to perform one or more actions. An ability to perform such action(s) may sometimes be referred to as a “skill.” That is, a skill may enable a skill system component(s) 925 to execute specific functionality in order to provide data or perform some other action requested by a user. For example, a weather service skill may enable a skill system component(s) 925 to provide weather information to the system component(s) 720, a car service skill may enable a skill system component(s) 925 to book a trip with respect to a taxi or ride sharing service, an order pizza skill may enable a skill system component(s) 925 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system component(s) 720 may be configured with a skill/app component 754 dedicated to interacting with the skill system component(s) 925. Unless expressly stated otherwise, reference to a skill, skill device, or skill component may include a skill/app component 754 operated by the system component(s) 720 and/or skill/app operated by the skill system component(s) 925. Moreover, the functionality described herein as a skill or skill may be referred to using many different terms, such as an action, bot, app, or the like. The skill component 754 and or skill system component(s) 925 may return output data to the orchestrator component 930.

The system component(s) includes a SSG component 756. The SSG component 756 may generate audio data (e.g., synthesized speech) from text data, text embeddings, text tokens, audio tokens, audio embeddings, etc., using one or more different methods. Data input to the SSG component 756 may come from a skill/app component 754, the orchestrator component 930, the action plan execution component 725, or another component of the system. In one method of synthesis called unit selection, the SSG component 756 matches data against a database of recorded speech. The SSG component 756 selects matching units of recorded speech and concatenates the units together to form audio data. In another method of synthesis called parametric synthesis, the SSG component 756 varies parameters such as frequency, volume, and noise to create audio data including an artificial speech waveform. Parametric synthesis uses a computerized voice generator, sometimes called a vocoder.

The user device 710 may include still image and/or video capture components such as a camera or cameras to capture one or more images. The user device 710 may include circuitry for digitizing the images and/or video for transmission to the system component(s) 720 as image data. The user device 710 may further include circuitry for voice command-based control of the camera, allowing a user 705 to request capture of image or video data. The user device 710 may process the commands locally or send audio data 911 representing the commands to the system component(s) 720 for processing, after which the system component(s) 720 may return output data that can cause the user device 710 to engage its camera.

The system component(s) 720/the user device 710 may include a user recognition component 995 that recognizes one or more users using a variety of data. However, the disclosure is not limited thereto, and the user device 710 may include the user recognition component 995 instead of and/or in addition to the system component(s) 720 without departing from the disclosure.

The user recognition component 995 may take as input the audio data 911 and/or text data output by the ASR component 950. The user recognition component 995 may perform user recognition by comparing audio characteristics in the audio data 911 to stored audio characteristics of users. The user recognition component 995 may also perform user recognition by comparing biometric data (e.g., fingerprint data, iris data, etc.), received by the system in correlation with the present user input, to stored biometric data of users assuming user permission and previous authorization. The user recognition component 995 may further perform user recognition by comparing image data (e.g., including a representation of at least a feature of a user), received by the system in correlation with the present user input, with stored image data including representations of features of different users. The user recognition component 995 may perform additional user recognition processes, including those known in the art.

The user recognition component 995 determines scores indicating whether user input originated from a particular user. For example, a first score may indicate a likelihood that the user input originated from a first user, a second score may indicate a likelihood that the user input originated from a second user, etc. The user recognition component 995 also determines an overall confidence regarding the accuracy of user recognition operations.

Output of the user recognition component 995 may include a single user identifier corresponding to the most likely user that originated the user input. Alternatively, output of the user recognition component 995 may include an N-best list of user identifiers with respective scores indicating likelihoods of respective users originating the user input. The output of the user recognition component 995 may be used to inform processing of the arbitrator component 982, the orchestrator component 930, and/or the language model orchestrator component 730 as well as processing performed by other components of the system.

The system component(s) 720/user device 710 may include a presence detection component that determines the presence and/or location of one or more users using a variety of data.

The system 100 (either on user device 710, system component(s), or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc.; input and output capabilities of the device; internet connectivity information; user bibliographic information; subscription information, as well as other information.

The profile storage 970 may include one or more user profiles, with each user profile being associated with a different user identifier/user profile identifier. Each user profile may include various user identifying data. Each user profile may also include data corresponding to preferences of the user. Each user profile may also include preferences of the user and/or one or more device identifiers, representing one or more devices of the user. For instance, the user account may include one or more internet protocol (IP) addresses, medium access control (MAC) addresses, and/or device identifiers, such as a serial number, of each additional electronic device associated with the identified user account. When a user logs into to an application installed on a user device 710, the user profile (associated with the presented login information) may be updated to include information about the user device 710, for example with an indication that the device is currently in use. Each user profile may include identifiers of components (e.g., responding component(s) 760 such as skills/apps, language model-based agents, knowledge bases, components for a particular domain, etc.) that the user has enabled. When a user enables a component, the user is providing the system component(s) with permission to allow the component to execute with respect to the user's inputs. If a user does not enable a component, the system component(s) may not invoke that component to execute with respect to the user's inputs.

The profile storage 970 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 970 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

In some embodiments, the system component(s) 720 may include one or more of the content moderation components 142, 620 and 650 described above in relation to FIGS. 1-6. The content moderation components 142/620/650 may receive data for processing from the orchestrator 930 and/or from the language model orchestrator 730.

Although the components of FIG. 9 may be illustrated as part of system component(s) 720, user device 710, or otherwise, the components may be arranged in other device(s) (such as in user device 710 if illustrated in system component(s) 720 or vice-versa, or in other device(s) altogether) without departing from the disclosure.

In at least some embodiments, the system component(s) 720 may receive the audio data 911 from the user device 710, to recognize speech corresponding to a spoken input in the received audio data 911, and to perform functions in response to the recognized speech. In at least some embodiments, these functions involve sending directives (e.g., commands), from the system component(s) to the user device 710 (and/or other user devices 710) to cause the user device 710 to perform an action, such as output an audible response to the spoken input via a loudspeaker(s), and/or control secondary devices in the environment by sending a control command to the secondary devices.

Thus, when the user device 710 is able to communicate with the system component(s) over the network(s) 199, some or all of the functions capable of being performed by the system component(s) may be performed by sending one or more directives over the network(s) 199 to the user device 710, which, in turn, may process the directive(s) and perform one or more corresponding actions. For example, the system component(s), using a remote directive that is included in response data (e.g., a remote response), may direct the user device 710 to output an audible response (e.g., using SSG processing performed by an on-device SSG component) to a user's question via a loudspeaker(s) of (or otherwise associated with) the user device 710, to output content (e.g., music) via the loudspeaker(s) of (or otherwise associated with) the user device 710, to display content on a display of (or otherwise associated with) the user device 710, and/or to send a directive to a secondary device (e.g., a directive to turn on a smart light). It is to be appreciated that the system component(s) may be configured to provide other functions in addition to those discussed herein, such as, without limitation, providing step-by-step directions for navigating from an origin location to a destination location, conducting an electronic commerce transaction on behalf of the user 705 as part of a shopping function, establishing a communication session (e.g., a video call) between the user 705 and another user, and so on.

In at least some embodiments, the user device 710, may send the audio data 911 to the wakeword detection component 920. If the wakeword detection component 920 detects a wakeword in the audio data 911, the wakeword detection component 920 may send an indication of such detection to the user device 710. In response to receiving the indication, the audio data 911 may be sent to the system component(s) 720 and/or the ASR component of the user device 710. The wakeword detection component 920 may also send an indication, to the user device 710, representing a wakeword was not detected. In response to receiving such an indication, the audio data 911 may not be sent to the system component(s) 720, and the user device 710 may prevent the ASR component of the user device 710 from further processing the audio data 911. In this situation, the audio data 911 can be discarded.

In some embodiments, the user device 710 may include some or all of the components illustrated in FIG. 9 and/or discussed herein above with respect to the system component(s) 720. In other embodiments, the components illustrated in FIG. 9 and/or discussed herein with respect to the system component(s) 720 may be distributed across the user device 710 and the system component(s) 720.

In at least some embodiments, the components of the user device 710 (e.g., on-device components) may not have the same capabilities as the components of the system component(s) 720. For example, on-device components may be configured to generate a response to only a subset of the natural language user inputs that may be handled by the system component(s) 720. For example, such subset of natural language user inputs may correspond to local-type natural language user inputs, such as those controlling devices or components associated with a user's home. In such circumstances the on-device components may be able to more quickly interpret and respond to a local-type natural language user input, for example, than processing that involves the system component(s). If the user device 710 attempts to process a natural language user input for which the on-device components are not necessarily best suited, the language processing results determined by the user device 710 may indicate a low confidence or other metric indicating that the processing by the user device 710 may not be as accurate as the processing done by the system component(s) 720.

In some embodiments, the system component(s) 720 and the user device 710 may process as described herein to generate responses to the user input corresponding to the audio data 911. The system component(s) 720 may send the response to the user device 710 and the user device 710 may determine whether to output the response generated by the system component(s) 720 or the response generated by the user device 710. In some embodiments, the system component(s) 720 may be configured to perform a portion of the processing described herein, such as a portion of processing not performable by the user device 710 and send the result of such processing to the user device 710. The user device 710 may be configured to determine whether to use the result to complete processing to generate the response to the user device 710.

In at least some embodiments, the user device 710 may include, or be configured to use, one or more skill/app components that may operate similarly to the skill /pp component(s) 754. The skill/app component(s) on the user device 710 may correspond to one or more domains that are used in order to determine how to act on a spoken input in a particular way, such as by outputting a directive that corresponds to the determined intent, and which can be processed to implement the desired operation. The skill component(s) installed on the user device 710 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally, or alternatively, the user device 710 may be in communication with one or more skill system component(s) 925. For example, a skill system component(s) 925 may be located in a remote environment (e.g., separate location) such that the user device 710 may only communicate with the skill system component(s) 925 via the network(s) 199. However, the disclosure is not limited thereto. For example, in at least some embodiments, a skill system component(s) 925 may be configured in a local environment (e.g., home server and/or the like) such that the user device 710 may communicate with the skill system component(s) 925 via a private network, such as a local area network (LAN).

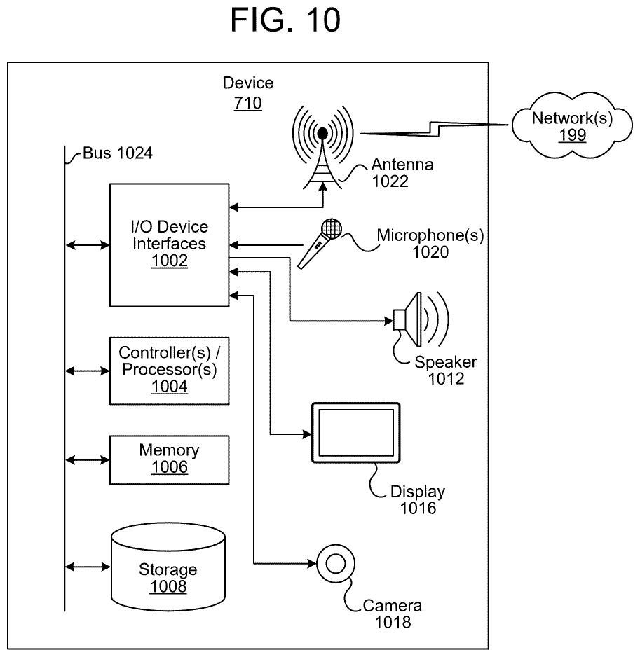

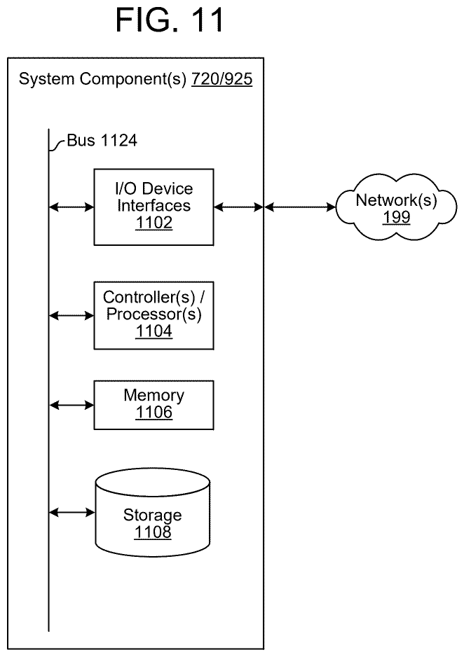

FIG. 10 is a block diagram conceptually illustrating a user device 710 that may be used with the system. FIG. 11 is a block diagram conceptually illustrating example components of a remote device, such as the system component(s) 720, which may assist with ASR processing, NLU processing, language model processing, etc., and a skill system component(s) 925. System component(s) (720/925) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the user device 710 may operate locally to a user (e.g., within a same environment so the device may receive inputs and playback outputs for the user) the server/system component(s) may be located remotely from the user device 710 as its operations may not require proximity to the user. The server/system component(s) may be located in an entirely different location from the user device 710 (for example, as part of a cloud computing system or the like) or may be located in a same environment as the user device 710 but physically separated therefrom (for example a home server or similar device that resides in a user's home or business but perhaps in a closet, basement, attic, or the like). The system component(s) 720 may also be a version of a user device 710 that includes different (e.g., more) processing capabilities than other user device(s) 710 in a home/office. One benefit to the server/system component(s) being in a user's home/business is that data used to process a command/return a response may be kept within the user's home, thus reducing potential privacy concerns.

Multiple system components (720/925) may be included in the overall system 100 of the present disclosure, such as one or more natural language processing system component(s) 720 for performing ASR processing, one or more natural language processing system component(s) 720 for performing NLU processing, one or more skill system component(s) 925, etc. In operation, each of these systems may include computer-readable and computer-executable instructions that reside on the respective device (720/925), as will be discussed further below.

Each of these devices (710/720/925) may include one or more controllers/processors (1004/1104), which may each include a central processing unit (CPU) for processing data and computer-readable instructions, and a memory (1006/1106) for storing data and instructions of the respective device. The memories (1006/1106) may individually include volatile random-access memory (RAM), non-volatile read only memory (ROM), non-volatile magnetoresistive memory (MRAM), and/or other types of memory. Each device (710/720/925) may also include a data storage component (1008/1108) for storing data and controller/processor-executable instructions. Each data storage component (1008/1108) may individually include one or more non-volatile storage types such as magnetic storage, optical storage, solid-state storage, etc. Each device (710/720/925) may also be connected to removable or external non-volatile memory and/or storage (such as a removable memory card, memory key drive, networked storage, etc.) through respective input/output device interfaces (1002/1102).

Computer instructions for operating each device (710/720/925) and its various components may be executed by the respective device's controller(s)/processor(s) (1004/1104), using the memory (1006/1106) as temporary “working” storage at runtime. A device's computer instructions may be stored in a non-transitory manner in non-volatile memory (1006/1106), storage (1008/1108), or an external device(s). Alternatively, some or all of the executable instructions may be embedded in hardware or firmware on the respective device in addition to or instead of software.

Each device (710/720/925) includes input/output device interfaces (1002/1102). A variety of components may be connected through the input/output device interfaces (1002/1102), as will be discussed further below. Additionally, each device (710/720/925) may include an address/data bus (1024/1124) for conveying data among components of the respective device. Each component within a device (710/720/925) may also be directly connected to other components in addition to (or instead of) being connected to other components across the bus (1024/1124).

Referring to FIG. 10, the user device 710 may include input/output device interfaces 1002 that connect to a variety of components such as an audio output component such as a speaker 1012, a wired headset or a wireless headset (not illustrated), or other component capable of outputting audio. The user device 710 may also include an audio capture component. The audio capture component may be, for example, a microphone 1020 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 710 may additionally include a display 1016 for displaying content. The user device 710 may further include a camera 1018.

Via antenna(s) 1022, the input/output device interfaces 1002 may connect to one or more networks 199 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (1002/1102) may also include communication components that allow data to be exchanged between devices such as different physical servers in a collection of servers or other components.

The components of the user device(s) 710, the system component(s) 720, or a skill system component(s) 925 may include their own dedicated processors, memory, and/or storage. Alternatively, one or more of the components of the user device(s) 710, the system component(s) 720, or a skill system component(s) 925 may utilize the I/O interfaces (1002/1102), processor(s) (1004/1104), memory (1006/1106), and/or storage (1008/1108) of the user device(s) 710, the system component(s) 720, or the skill system component(s) 925, respectively. Thus, the ASR component 950 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the user device 710, the system component(s) 720, and a skill system component(s) 925, as described herein, are illustrative, and may be located as a stand-alone device or may be included, in whole or in part, as a component of a larger device or system. As can be appreciated, a number of components may exist either as a system component(s) and/or on user device 710. Unless expressly noted otherwise, the system version of such components may operate similarly to the user device version of such components and thus the description of one version (e.g., the system version or the local user device version) applies to the description of the other version (e.g., the local user device version or system version) and vice-versa.

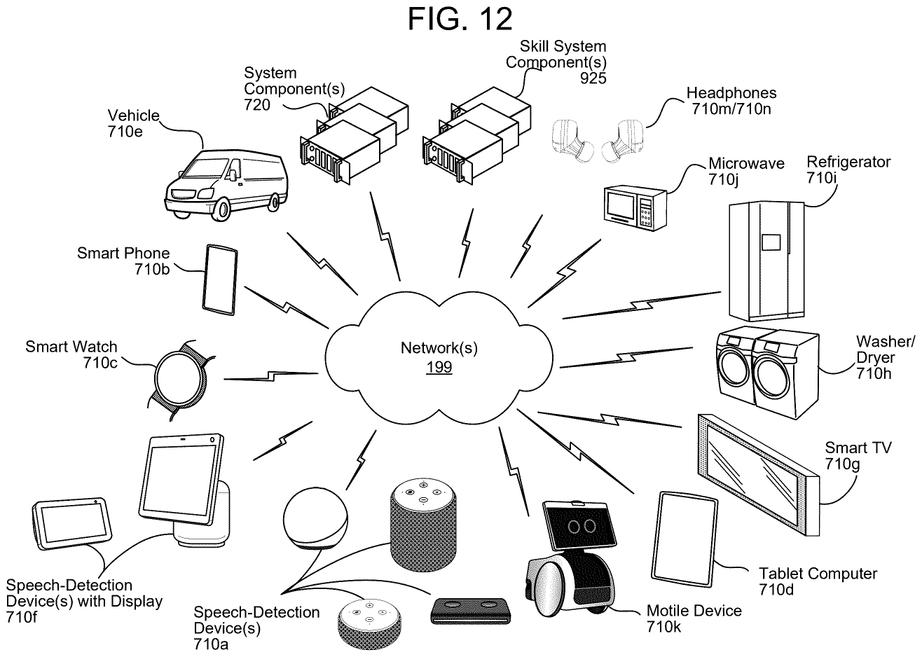

As illustrated in FIG. 12, multiple devices (710a-710n, 720, 925) may contain components of the system and the devices may be connected over a network(s) 199. The network(s) 199 may include a local or private network or may include a wide network such as the Internet. Devices may be connected to the network(s) 199 through either wired or wireless connections. For example, a speech-detection user device 710a, a smart phone 710b, a smart watch 710c, a tablet computer 710d, a vehicle 710e, a speech-detection device with display 710f, a display/smart television 710g, a washer/dryer 710h, a refrigerator 710 i, a microwave 710j, autonomously motile user device 710k (e.g., a robot), headphones 710m/710n (e.g., wireless earbuds, wireless headphones), etc., may be connected to the network(s) 199 through a wireless service provider, over a Wi-Fi or cellular network connection, or the like. Other devices are included as network-connected support devices, such as the system component(s) 720, the skill system component(s) 925, and/or others. The support devices may connect to the network(s) 199 through a wired connection or wireless connection. Networked devices may capture audio using one-or-more built-in or connected microphones or other audio capture devices, with processing performed by components of the same device or another device connected via the network(s) 199, such as the system component(s) 720.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
receiving text data representing a natural language user input;
determining a first prompt including the text data and a first request to generate a response to the natural language user input;
generating, by a first language model and based on the first prompt, a first number of tokens corresponding to a first portion of the response;
processing, using a second language model, the first number of tokens to determine that the first portion of the response corresponds to a non-moderated content category, wherein the second language model is configured to determine whether inputted tokens correspond to one or more of a set of moderated content categories;
in response to the first portion of the response corresponding to the non-moderated content category, causing presentation of the first number of tokens;
generating, by the first language model and based on the first prompt, a second number of tokens corresponding to a second portion of the response, wherein the second number is larger than the first number;
processing, using the second language model, the second number of tokens to determine that the second portion of the response corresponds to the non-moderated content category; and
in response to the second portion of the response corresponding to the non-moderated content category, causing presentation of the second number of tokens.

2. The computer-implemented method of claim 1, further comprising:
determining a confidence score associated with the second language model processing of the second number of tokens;
determining that the confidence score satisfies a condition;
based on the confidence score satisfying the condition, determining a third number of tokens to be processed by the second language model, wherein the third number is larger than the second number;
generating, based on the first language model processing the first prompt, the third number of tokens corresponding to a third portion of the response;
processing, using the second language model, the third number of tokens to determine that the third portion of the response corresponds to the non-moderated content category; and
in response to the third portion of the response corresponding to the non-moderated content category, causing presentation of the third number of tokens.

3. The computer-implemented method of claim 1, further comprising:
determining a second prompt including the first number of tokens and a second request to determine whether the first portion of the response corresponds to one of a set of moderated content categories, wherein processing, using the second language model, the first number of tokens comprises processing the second prompt using the second language model;
determining, based on the second language model processing the second prompt, embedding data corresponding to the second prompt; and
determining a third prompt including the first number of tokens, the second number of tokens and a third request to determine whether the first portion of the response and the second portion of the response correspond to one of the set of moderated content categories,
wherein processing, using the second language model, the second number of tokens comprises processing, using the second language model, the embedding data and a third portion of the third prompt.

4. The computer-implemented method of claim 1, further comprising:
generating, based on the first language model processing the first prompt, a third number of tokens corresponding to a third portion of the response;
processing, using the second language model, the third number of tokens to determine that the third portion of the response corresponds to a first moderated content category;
ceasing generation of further tokens by the first language model;
determining first data corresponding to the first moderated content category, the first data including instructions to generate an output corresponding to the non-moderated content category instead of the first moderated content category;
in response to the third portion of the response corresponding to the first moderated content category, determining a second prompt including the text data, the first data and a second request to generate a response to the natural language user input based on the first data;
processing, using the first language model, the second prompt to determine a second response to the natural language user input; and
causing presentation of the second response.

5. A computer-implemented method comprising:
receiving user input data;
processing, using a first generative model, the user input data to generate first tokens corresponding to a first portion of a response to the user input data;
determining that the first tokens correspond to a first content category;
in response to the first tokens corresponding to the first content category, sending the first tokens to a system component for further processing;
while sending the first tokens to the system component, processing, using the first generative model, to generate second tokens corresponding to a second portion of the response to the user input data;
determining the second tokens correspond to the first content category; and
in response to the second tokens corresponding to the first content category, sending the second tokens to the system component for further processing.

6. The computer-implemented method of claim 5, further comprising:
based on determining the first tokens correspond to the first content category, determining a number of the second tokens to be processed, wherein the second tokens include a larger number of tokens than the first tokens.

7. The computer-implemented method of claim 5, further comprising:
determining, using a trained model, that the second tokens correspond to the first content category, wherein the trained model is configured to determine whether inputted tokens correspond to one or more of a set of moderated content categories; and
based on the trained model processing of the second tokens, determining a number of tokens to be subsequently processed by the trained model.

8. The computer-implemented method of claim 5, further comprising:
processing, using the first generative model for a first generation step to generate the first tokens; and
based on determining that the first tokens correspond to a non-moderated content category, processing, using the first generative model for a plurality of generation steps to generate the second tokens.

9. The computer-implemented method of claim 5, further comprising:
determining a first prompt including a first request to determine whether the first tokens correspond to one or more of a set of moderated content categories,
determining, using a second generative model and the first prompt, that the first tokens correspond to the first content category; and
storing embedding data corresponding to the second generative model processing of the first prompt.

10. The computer-implemented method of claim 9, further comprising:
determining a second prompt including a second request to determine whether the second tokens correspond to one of the set of moderated content categories; and
processing, using the second generative model, the embedding data and a portion of the second prompt to determine that the second tokens correspond to the first content category.

11. The computer-implemented method of claim 5, further comprising:
processing, using first generative model, to generate third tokens corresponding to a first response including the first tokens and second tokens;
determining that the third tokens correspond to a second content category; and
in response to determining that the third tokens correspond to the second content category, processing the user input data using the first generative model to generate fourth tokens corresponding to a second response.

12. The computer-implemented method of claim 5, further comprising:
processing, using first generative model, to generate third tokens corresponding to a first response including the first tokens and second tokens;
determining that the third tokens correspond to a second content category;
determining instructions to generate an output corresponding to a third content category instead of the second content category; and
processing, using the first generative model, the user input data and the instructions to generate a second response to the user input data.

13. A system comprising:
at least one processor; and
at least one memory including instructions that, when executed by the at least one processor, cause the system to:
receive user input data;
process, using a first generative model, the user input data to generate first tokens corresponding to a first portion of a response to the user input data;
determine that the first tokens correspond to a first content category;
in response to the first tokens corresponding to the first content category, send the first tokens to a system component for further processing;
while sending the first tokens, process, using the first generative model, to generate second tokens corresponding to a second portion of the response to the user input data;
determine the second tokens correspond to the first content category; and
in response to the second tokens corresponding to the first content category, send the second tokens to the system component for further processing.

14. The system of claim 13, wherein the at least one memory includes further instructions that, when executed by the at least one processor, further cause the system to:
based on determining the first tokens correspond to the first content category, determine a number of the second tokens to be processed, wherein the second tokens include a larger number of tokens than the first tokens.

15. The system of claim 13, wherein the at least one memory includes further instructions that, when executed by the at least one processor, further cause the system to:
determine, using a trained model, that the second tokens correspond to the first content category, wherein the trained model is configured to determine whether inputted tokens correspond to one or more of a set of moderated content categories; and
based on the trained model processing of the second tokens, determine a number of tokens to be subsequently processed by the trained model.

16. The system of claim 13, wherein the at least one memory includes further instructions that, when executed by the at least one processor, further cause the system to:
process, using the first generative model for a first generation step to generate the first tokens; and
based on determining that the first tokens correspond to a non-moderated content category, process, using the first generative model for a plurality of generation steps to generate the second tokens.

17. The system of claim 13, wherein the at least one memory includes further instructions that, when executed by the at least one processor, further cause the system to:
determine a first prompt including a first request to determine whether the first tokens correspond to one or more of a set of moderated content categories,
determine, using a second generative model and the first prompt, that the first tokens correspond to the first content category; and
store embedding data corresponding to the second generative model processing of the first prompt.

18. The system of claim 17, wherein the at least one memory includes further instructions that, when executed by the at least one processor, further cause the system to:
determine a second prompt including a second request to determine whether the second tokens correspond to one of the set of moderated content categories; and
process, using the second generative model, the embedding data and a portion of the second prompt to determine that the second tokens correspond to the first content category.

19. The system of claim 13, wherein the at least one memory includes further instructions that, when executed by the at least one processor, further cause the system to:
process, using first generative model, to generate third tokens corresponding to the first response including the first tokens and second tokens;
determine that the third tokens correspond to a second content category; and
in response to determining that the third tokens correspond to the second content category, process the user input data using the first generative model to generate fourth tokens corresponding to a second response.

20. The system of claim 13, wherein the at least one memory includes further instructions that, when executed by the at least one processor, further cause the system to:
process, using first generative model, to generate third tokens corresponding to a first response including the first tokens and second tokens;
determine that the third tokens correspond to a second content category;
determine instructions to generate an output corresponding to a third content category instead of the second content category; and
process, using the first generative model, the user input data and the instructions to generate a second response to the user input data.
